(19) United States
(12) Patent Application Publication
(10) Pub. No.: US 2003/0202091 A1
(43) Pub. Date: Oct. 30, 2003

(54) Modular assisted visualization system

(76) Inventors: Jaime Garcia, Jackson, TN (US); Kathy Dekeyser, Jackson, TN (US); John Larkin, Santa Clara, CA (US); Dan Adams, Menlo Park, CA (US); Helen Diane Shaughnessy, Mountain View, CA (US); Angela Wahab, Tigard, OR (US); Christine McElhaney, Palo Alto, CA (US); Sascha Retailleau, San Francisco, CA (US); David Christopher Shafer, Menlo Park, CA (US); Kathy Hannon Davies, Fremont, CA (US)

Correspondence Address: SUITER WEST PC LLO, 14301 FNB PARKWAY, SUITE 220, OMAHA, NE, 68154, US

(21) Appl. No.: 10/413,455

(22) Filed: Apr. 14, 2003

Related U.S. Application Data
(60) Provisional application No. 60/373,752, filed on Apr. 18, 2002.
(60) Provisional application No. 60/414,200, filed on Sep. 27, 2002.

(51) Int. Cl. H04N 7/18

(52) U.S. Cl. 348/86; 382/152

(57) ABSTRACT

A modular assisted visualization system includes an image manipulation module in communication with a work piece manipulation device, a camera module and at least one remote image manipulation module. The camera module, which is coupled to the work piece manipulation device and includes a camera lens and a light, provides a visual image of a work area of the work piece manipulation device. The visual image provided is displayed on the image manipulation module. The image manipulation module lays down at least one of a grid and a cut line on a work piece, by using the camera lens. The grid or cut line is established by data received by the image manipulation module from an operator. The work piece manipulation device, controlled by the image manipulation module, is engaged upon the grid or cut line established on the work piece.

### CROSS REFERENCE TO RELATED APPLICATION

The present application claims priority under 35 U.S.C. §119 to the U.S. Provisional Application Serial No. 60/373,752, filed on Apr. 18, 2002, and United States Provisional Application Serial No. 60/414,200, filed on Sep. 27, 2002. Both United States Provisional Applications are herein incorporated by reference in their entireties.

### FIELD OF THE INVENTION

The present invention generally relates to the field of power tools, and particularly to a modular assisted visualization system disposed upon a power tool, such as a circular saw, band saw, jointer, planer, wood shaper, router, borer, drill press, sander, abrasive finishing machine, lathe, laser cutter, water jet cutter, and the like.

### BACKGROUND OF THE INVENTION

The use of power tools to change the shape of a work piece is commonplace. Power tools such as circular saws, drills, lathes, sanders, laser cutters, water jet cutters, and the like, are employed to accomplish numerous tasks. These tools have increased production capabilities in the work place and in home workshops.

With the increase in production capabilities, the risk of accident and injury involving an operator of a power tool has increased. Operators of power tools are generally required to establish the location upon the work piece where the power tool is to execute its function. Furthermore, power tools may require an operator to maintain a line of sight on that location throughout the process of utilizing the power tools. The need to maintain the line of sight distracts the attention of the operator from the operation of the power tool. Moreover, maintaining the line of sight may require the operator to be in close proximity to the working end of the power tool. Thus, the distraction of establishing and maintaining a line of sight, and the proximity requirement place the operator in a dangerous position, increasing the risk of accident and injury.

Safety features, such as blade guards, kill switches, safety cages/shields, and the like, have been added to power tools. Additionally, many power tool motors are housed in protective enclosures. Even though such safety features provide protection, power tools with such features may continue to require an operator to perform within close proximity of the power tools.

Therefore, it would be desirable to provide a modular assisted visualization system which allows a geographically remote operator of a power tool to establish a location upon a work piece for the execution of the function of the power tool and to execute the function of the power tool upon the work piece at the specified location.

### SUMMARY OF THE INVENTION

Accordingly, the present invention is directed to a modular assisted visualization system for providing an operator of a work piece manipulation device, such as a circular saw, drill press, sander, lathe, laser cutter, water jet cutter, and the like, the ability to establish precise manipulation points on a work piece and control the work piece manipulation device function (e.g., cut, drill, sand), from a remote location through the use of interactive display and programmable interfaces. The system provides increased operator safety by allowing the operator to remotely manipulate the work piece. Additionally, the system increases work piece production quantity and quality by reducing the effects of human error in establishing and performing a manipulation function on one or many work pieces.

In a first aspect of the present invention, a modular assisted visualization system is disposed upon a work piece manipulation device and includes a camera module and an image manipulation module. The modular assisted visualization system provides an operator a visual image of a work area of the work piece manipulation device. The modular assisted visualization system allows the operator to perform an operation on the work piece from a remote location. The features of the modular assisted visualization system provide increased operator safety and more precise repetitive cuts. This system reduces the need for physical exertion by an operator which increases production capabilities and decreases production time.

In a second aspect of the present invention, a modular assisted visualization system is disposed upon a saw and includes a camera module and an image manipulation module. The modular assisted visualization system provides an operator a visual image of a work area of the saw allowing the operator to perform an operation on the work piece from a remote location. The modular assisted visualization system provides increased operator safety and more precise repetitive cuts, and the system reduces the need for physical exertion by an operator, in this manner increasing production capabilities and decreasing production time.

In a third aspect of the present invention, a system for furnishing a finished work piece is provided. In one embodiment the system includes a modular assisted visualization system in communication with a programmable work piece hopper, a saw controller, which controls a saw, and a conveyance mechanism. The system provides an operator the capability of selecting and accessing a work piece from the work piece hopper, having that work piece delivered to the saw, indexed to the appropriate cut locations, having the saw perform the desired cuts, and then having the finished work piece delivered to a desired location. The modular assisted visualization system provides increased operator safety and more precise repetitive cuts, and the system reduces the need for physical exertion by an operator, in this manner increasing production capabilities and decreasing production time. In addition, the current system reduces workforce requirements which may substantially improve the cost of production for a business.

In a fourth aspect of the present invention, a method for manipulation of a work piece allows an operator to select a work piece, program in the desired cut(s), have the work piece cut to size, and then deliver the work piece to a specific location. This method provides an advantage over previous systems in that the operator may be remotely located from the work piece and the saw, be able to produce the needed size work piece, and have that work piece delivered to a location that the operator specifies.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description serve to explain the principles of the invention.

### BRIEF DESCRIPTION OF DRAWINGS

The numerous advantages of the present invention may be better understood by those skilled in the art by reference to the accompanying figures in which:

FIG. 1A is a side elevation isometric view of an operator employing a modular assisted visualization system within a system to accomplish the selection, shaping and delivery of a finished work piece to the location of the operator;

FIG. 1B is a flowchart representation of the functional capabilities of the modular assisted visualization system as shown in FIG. 1A;

FIG. 2 is a top plan view of a system employing the modular assisted visualization system with the capabilities of delivering finished work pieces to multiple locations;

FIG. 3A is an isometric view of the modular assisted visualization system including component parts;

FIG. 3B is a diagrammatic representation of an exemplary information handling system, which may be employed within the modular assisted visualization system;

FIG. 4 is a diagram illustrating functional steps involved in the use of the modular assisted visualization system;

FIG. 5 is an isometric view of a remote image manipulation module in accordance with an exemplary embodiment of the present invention;

FIG. 6 is a front plan view of the remote image manipulation module, as shown in FIG. 5, illustrating the display seen by an operator of the remote image manipulation module at a step 1;

FIG. 7 is a front plan view of the remote image manipulation module, as shown in FIG. 5, illustrating the display seen by an operator of the remote image manipulation module at a step 2;

FIG. 8 is a front plan view of the remote image manipulation module, as shown in FIG. 5, illustrating the display seen by an operator of the remote image manipulation module at a step 3;

FIG. 9 is a front plan view of the remote image manipulation module, as shown in FIG. 5, illustrating the display seen by an operator of the remote image manipulation module at a step N, where N represents a final step with a number determined by the use of the remote image manipulation module by the operator;

FIG. 10 is an isometric view of an exemplary saw, of the modular assisted visualization system, cutting a work piece visually marked with indicators which are identified by a camera module, which is coupled to the saw and the remote image manipulation module, of FIG. 5, displaying a view of a work area provided by the camera;

FIG. 11 is an isometric view of the exemplary saw, shown in FIG. 10, after the saw has finished cutting an exemplary work piece and the remote image manipulation module, of FIG. 5, is displaying the view of the work area provided by the camera with an enhanced image that does not include the debris present in the work area being viewed by the camera;

FIG. 12 is a close up view of the displayed image on the remote image manipulation module of FIG. 11;

FIG. 13 is a front plan view of the display of the remote image manipulation module of FIG. 5, indicating the ability of the remote image manipulation module to determine the function of a camera to which it is in communication;

FIG. 14 is an isometric view of an exemplary embodiment of the present invention where the camera is identifying the visual indicator on the work piece in the work area, and the saw further includes a stabilizer mechanism;

FIG. 15 is a side elevation view of FIG. 14 where it is indicated that the stabilizer mechanism serves not only as a brace but as a system for moving the work piece while engaged with the saw;

FIG. 16 is a top plan view of exemplary embodiment of the present invention shown in FIG. 14;

FIG. 17 is a side elevation view of an exemplary embodiment of the present invention which includes a saw controller coupled to the saw;

FIG. 18 is a flowchart indicating functional steps that are accomplished by the modular assisted visualization system shown in FIG. 17;

FIG. 19 is an isometric view of a tape measuring device which may be utilized in conjunction with an exemplary embodiment of the present invention;

FIG. 20 is a side elevation view of an electronic measuring device which may be utilized in conjunction with an exemplary embodiment of the present invention;

FIG. 21 is an isometric view of an operator breaching the protective barrier of a safety guard coupled with the saw which is further coupled with the camera of the present invention;

FIG. 22 is an isometric view of FIG. 21 where the protective barrier of the safety guard has not been breached and the saw is engaging a work piece in the work area;

FIG. 23 is an isometric view of the modular assisted visualization system coupled to an adjustable cut angle circular saw;

FIGS. 24A and 24B are a flowchart illustration of functional steps that are accomplished by the modular assisted visualization system coupled to the adjustable cut angle circular saw as shown in FIG. 23;

FIG. 25 is an isometric view of an exemplary embodiment of the present invention where a saw controller is coupled directly to the saw;

FIG. 26 is a flowchart illustration of functional steps that are accomplished by a system which provides to an operator the functional capability to select a work piece, have the work piece cut to size, and have the cut work piece delivered to a specific location;

FIG. 27 is an isometric view of a hopper which includes various types, numbers, and sizes of work pieces from which an operator may select;

FIG. 28 is a side elevation view of an elevator, which is part of a conveyance mechanism, for delivering work pieces to a specific location as directed by an operator;

FIG. 29 is an isometric view of a housing capable of connecting with a conveyance mechanism for delivering the work piece to a specific location;

FIG. 30 is a cut-away side elevation view of the transportable housing of FIG. 29, showing the housing capable of providing a hopper for storage and access of the work piece, a saw for cutting the work piece, a modular assisted visualization system and a conveyance mechanism for delivering the work piece;

FIGS. 31A, 31B and 31C illustrate a marker, used in conjunction with the modular assisted visualization system, which places an indicator upon the work piece, the indicator is capable of being identified by the camera coupled to the saw;

FIGS. 32, 33 and 34 illustrate isometric views of a remote viewing module capable of coupling with the camera module and displaying the image of the work area provided by the camera module to the operator of the modular assisted visualization system;

FIG. 35 is an isometric view of a reverse action circular saw disposed in a housing suitable for use in the modular assisted visualization system;

FIG. 36 is an isometric view of a saw drawer, for use in the modular assisted visualization system;

FIG. 37 is a side elevation view of a system which utilizes the modular assisted visualization system including the saw, the hopper, and the conveyance mechanism to allow an operator to select the work piece, cut the work piece to the desired shape and deliver the work piece to a specific location;

FIG. 38 is a diagrammatic representation of a system utilizing a plurality of water saws, that includes a reservoir for storing and collecting water, a pump for distributing water, and a plurality of accumulators for providing water, received from the pump, directly to the plurality of water saws;

FIG. 39 is an isometric view of a water saw coupled with the modular assisted visualization system; and

FIG. 40 is a side elevation view of the water saw of FIG. 39.

### DETAILED DESCRIPTION

Reference will now be made in detail to the presently preferred embodiments of the invention, examples of which are illustrated in the accompanying drawings.

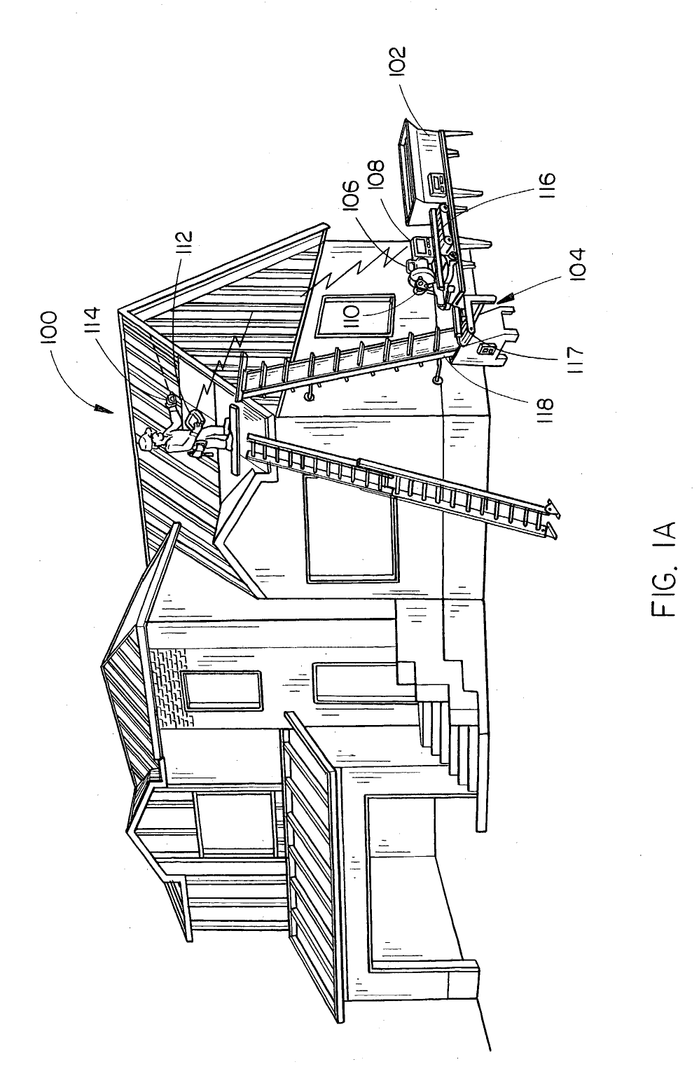

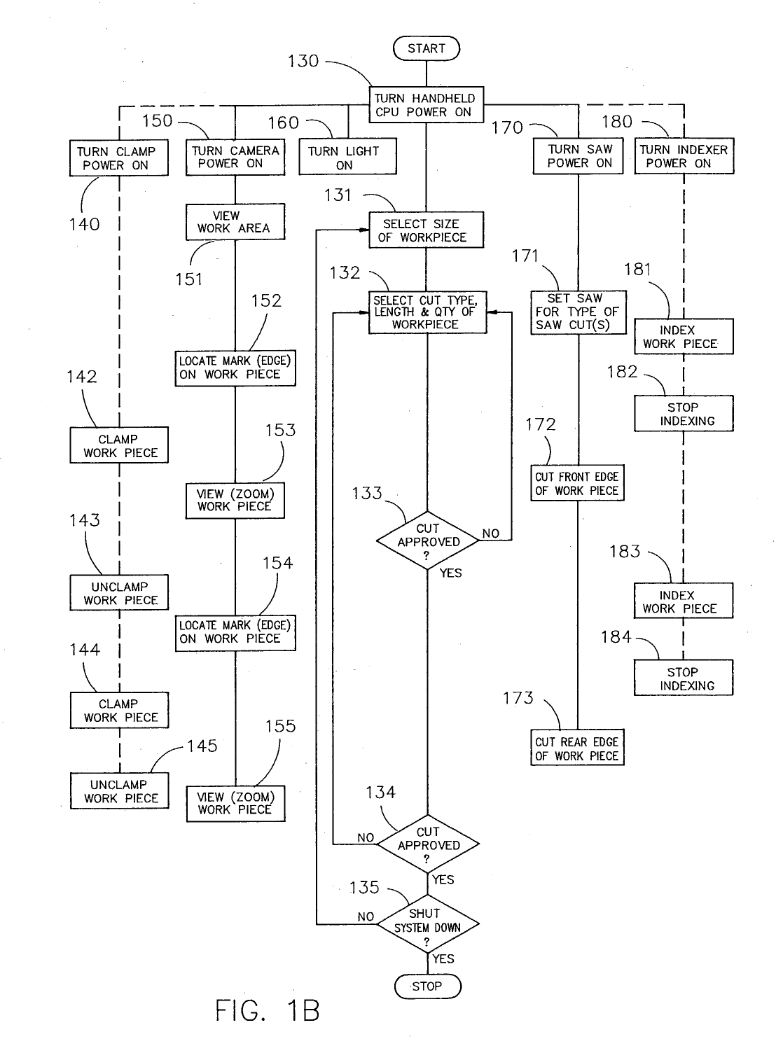

Referring to FIG. 1A a modular assisted visualization system 100, is shown in an exemplary workplace environment. The system 100 includes a hopper 102 for storing work pieces, a conveyance mechanism 104 for delivering the work pieces to a particular location, and a circular saw 106. The circular saw 106 may be a miter saw, radial arm saw, table saw and the like. Alternately, the system may comprise a drill, a sander, a lathe, a laser cutter, a water jet cutter, or another mechanism as contemplated by one of ordinary skill in the art.

The modular assisted visualization system 100 includes an image manipulation module 108 which is in communication with a camera module 110 and a remote image manipulation module 112. Additionally, the image manipulation module 108 is in communication with and capable of controlling the operation of the circular saw 106, the conveyance mechanism 104 and the hopper 102. A measuring device 114 is in communication with the remote image manipulation module 112.

In the embodiment shown, an operator is employing the measuring device 114 in order to determine the size of the work piece needed at a specific location. Preferably, the measuring device 114 is an electronic measuring device, however, other measuring device systems may be employed as contemplated by one of ordinary skill in the art. The information gathered by the electronic measuring device 114 is then communicated to the remote image manipulation module 112. It is contemplated that the measuring device 114 may be in communication with the image manipulation module 108, therefore, able to provide the information directly to the image manipulation module 108. The communication of the information from the electronic measuring device 114 to the remote image manipulation module 112 may be accomplished by the operator manually entering the information into the remote image manipulation module. Alternately, the measuring device 114 may use a variety of communication methods for communicating with the remote image manipulation module 112, such as sending and receiving analog signals, digital signals, radio-frequencies, infrared signals, and the like.

In the present embodiment the hopper 102 is programmable by the operator through the image manipulation module 108. The hopper 102 includes a single size and type of work piece, however, in alternate embodiments the hopper may include a variety of different types and sizes of work pieces. The hopper may accommodate such variety through the use of compartments within the hopper or other such systems as may be contemplated by one of ordinary skill in the art. It is understood that the hopper 102 may assume a variety of configurations and programmable functions without departing from the scope and spirit of the present invention.

Preferably, the conveyance mechanism 104 includes an indexer 116 that runs from the hopper 102 to the circular saw 106. The indexer 116 may be programmed, by the operator through the image manipulation module 108, to index the work piece to a particular length upon the circular saw 106. The operator verifies the proper indexing of the work piece upon the circular saw 106, through use of the remote image manipulation module 112 or the image manipulation module 108 which displays the image of the work area provided by the camera module 110.

After the circular saw 106 has been properly engaged upon the work piece the conveyor belt 117 delivers the cut work piece to an elevator 118. In the current embodiment, the elevator 118 is capable of being programmed by the operator as it is in communication with the image manipulation module 108. The elevator provides the capability of delivering the cut work piece to a specific location in vertical relation to the conveyor belt 117. The conveyance mechanism 104 may be comprised of a variety of different units to accomplish its purpose without departing from the scope and spirit of the present invention.

The elevator 118 may include an elevator controller mechanism which is manually or electronically programmable. The image manipulation module 108 may be in communication with the electronically programmable elevator, maintaining control over its operation. Alternately, the operator may be required to manually program the elevator once it has been located in the desired position. Another aspect of the elevator controller mechanism may provide an electronically programmable mechanism that is independent of the image manipulation module 108. In such an instance the operator may utilize a handheld remote elevator controller mechanism to program the elevator.

The conveyance mechanism 104 may include a conveyance mechanism controller. The conveyance mechanism controller, in communication with the image manipulation module 108, allows an operator to program the indexing and delivery of the work piece. Alternately, the conveyance mechanism controller may allow an operator to program the indexing and delivery of the work piece, independent of the image manipulation module 108. In either configuration the conveyance mechanism controller is in communication with the hopper 102 and the elevator 118. Additionally, the conveyance mechanism controller may be a handheld information handling system capable of allowing an operator to control the conveyance mechanism, including the elevator 118 and the hopper 102, from a geographically remote location.

Preferably, the circular saw 106 is a miter saw, however, it is understood by those of ordinary skill in the art that the circular saw may be a table saw, radial arm saw, laser cutter, water jet cutter, or the like, without departing from the scope and spirit of the present invention. In this exemplary embodiment the circular saw 106 is operationally controlled by the image manipulation module, however, it is contemplated that a saw controller may be in communication with and control the operation of the circular saw 106. Thus, the image manipulation module 108 is in communication with the saw controller which then communicates any commands directly to the circular saw 106.

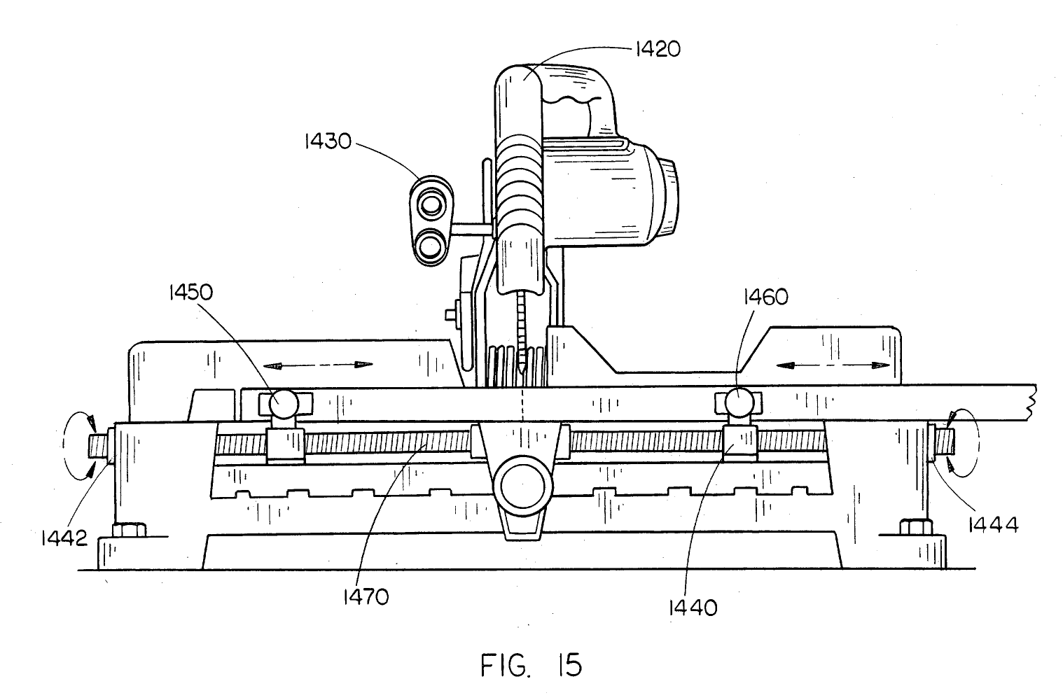

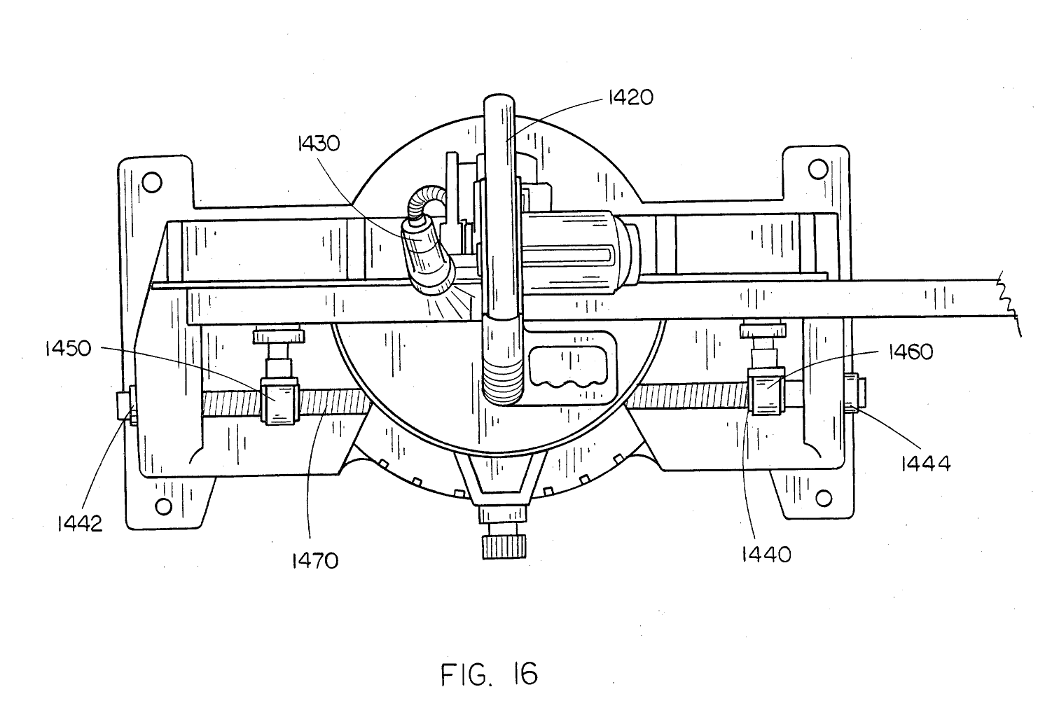

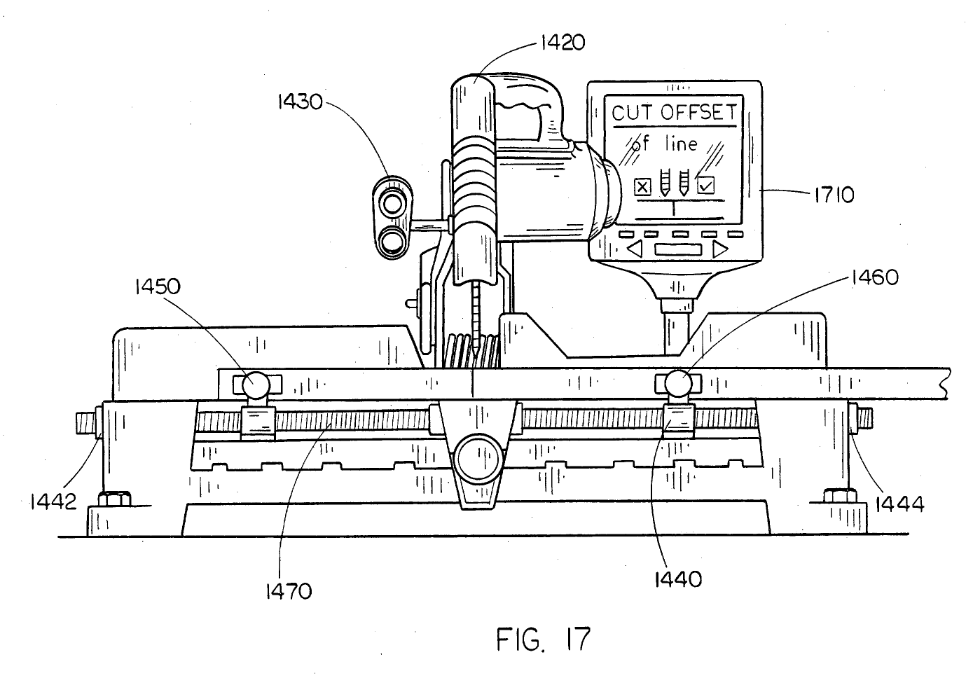

The circular saw may further include a clamp system connected to its base. The clamp system may require manual operation or it may be an electronic, programmable system. The image manipulation module 108 is in communication with the electronic, programmable clamp system and controls its operation. Alternately, a clamp controller may be employed to control the electronic, programmable clamp system. The electronic, programmable clamp system will be further described in FIGS. 14 through 17.

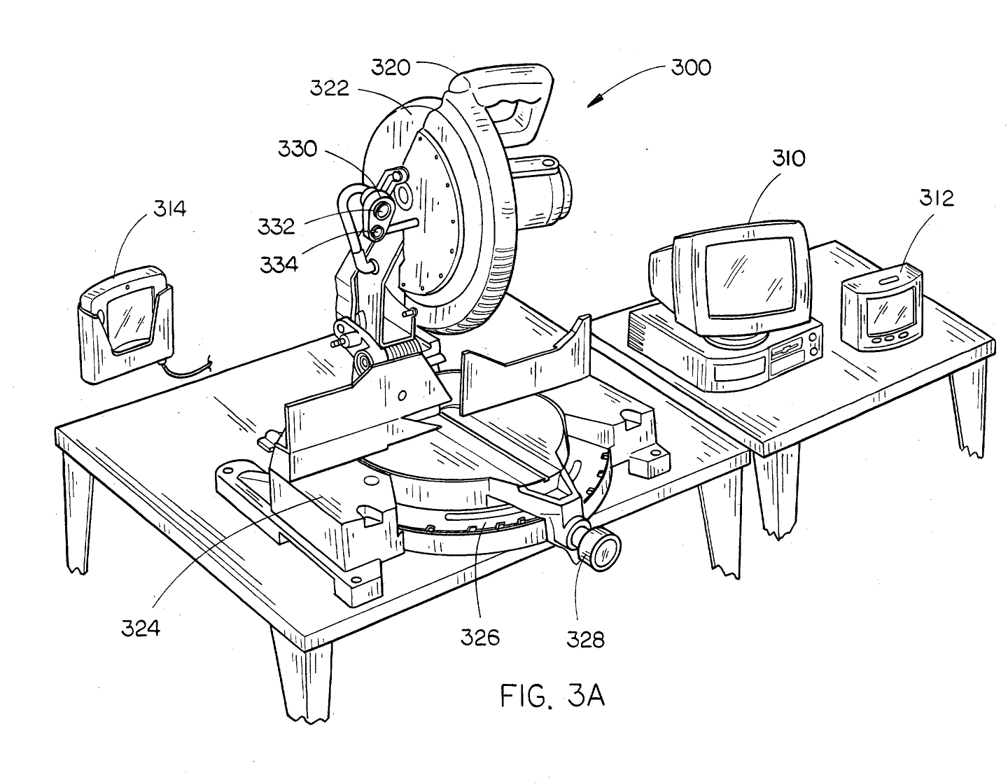

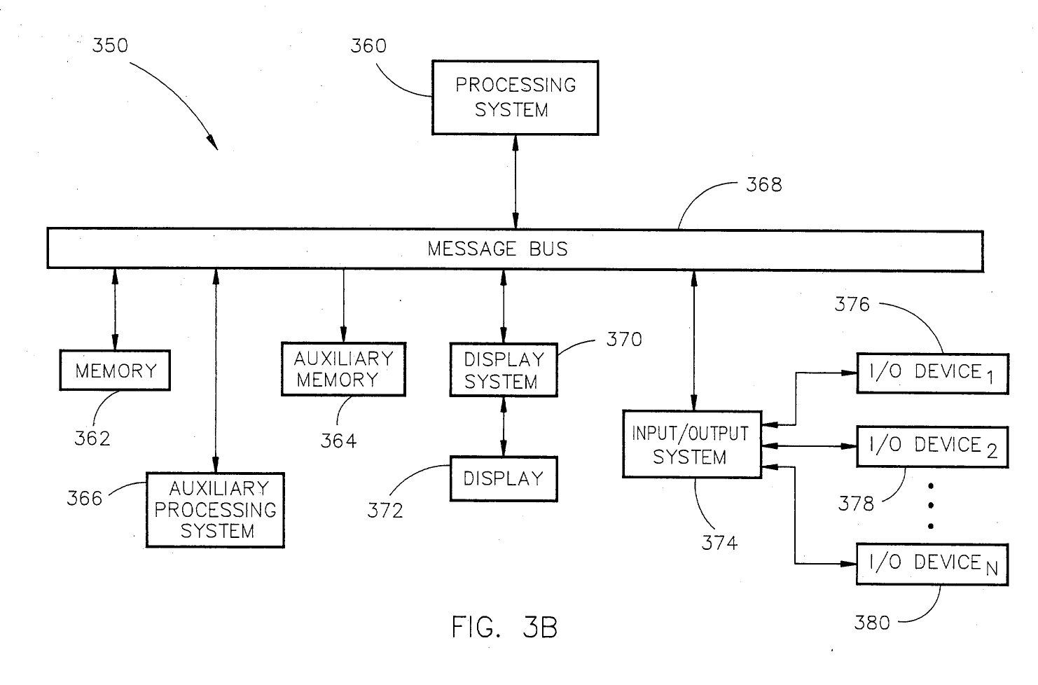

The image manipulation module 108 is an information handling system with a display unit attached, in the present embodiment. The information handling system may be a personal computer (PC), a palm pilot, or the like, as contemplated by one of ordinary skill in the art. Communication with the other devices is generally accomplished through the use of radio frequencies but may be accomplished by serial cable, infrared (IR), or other communication mediums. Preferably, the display attached to the image manipulation module 108 is a liquid crystal display, however, it is contemplated that other display modes and monitors may be utilized without departing from the scope and spirit of the present invention. A standard keyboard, connected to the image manipulation module 108, may be used to enter information into the image manipulation module 108. A keypad or other data entry mechanism may be employed, either directly connected or in remote communication with the image manipulation module 108. The configuration of image manipulation module 108 and the remote image manipulation module 112 is discussed below in FIG. 3.

The image manipulation module 108 accepts images of the work area from the camera module 110. Preferably, the camera module 110 is coupled with the circular saw 106 in a location that provides the camera module 110 a clear and unobstructed view of the work area of the circular saw 106. The camera module 110 may be removable from the circular saw 106 and the coupling may allow for a variety of camera modules to be connected to the circular work saw. The camera module 110 may include a camera with a zoom lens and a light to provide additional lighting to the work area. The work area may be defined as that area of the circular saw 106 in which the work piece may be engaged and cut by the circular saw 106. However, the operator may position the camera module 110 in a manner that provides an image of a desired work area, outside what is typically defined as the work area.

Upon receiving the image of the work area from the camera module 110, the image manipulation module 108 displays that image. In accord with the measurement information given by the operator (either directly or through the remote image manipulation module) the image manipulation module 108 lays down a cut line or a grid. The cut line is visually established on the work piece through the camera module 110, allowing the operator to see and verify the accuracy of the proposed cut line. If the operator is dissatisfied with the cut line that has been established then a change may be made by entering new information into the image manipulation module 108. Once this new information is received the work piece, through use of the conveyance mechanism 104, may have its position adjusted.

In the present exemplary embodiment the image manipulation module 108 controls the indexing capability of system 100. Through the communicative connection between the image manipulation module 108 and the conveyance mechanism 104 the operator may adjust the position of the work piece on the circular saw 106. Additionally, the operator may control the conveyance mechanism 104, and index a work piece on the circular saw 106, through use of the remote image manipulation module 112.

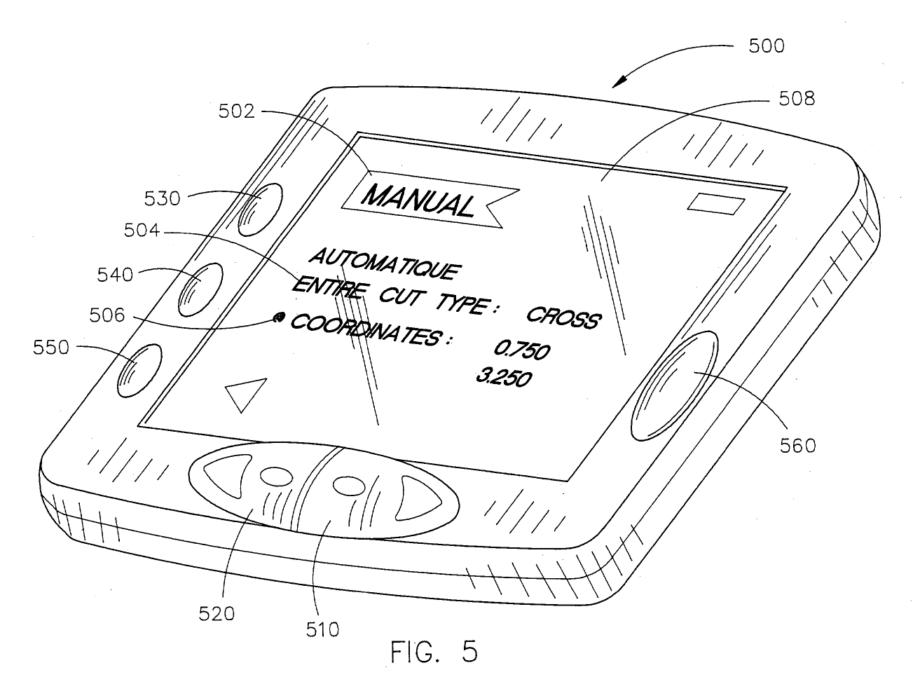

The remote image manipulation module 112 is a handheld information handling system with a liquid crystal display. It enables an operator of the modular assisted visualization system to be geographically distant from the image manipulation module 108 and maintain control over the functioning of the image manipulation module 108. The remote image manipulation module 112 will be further discussed below in the description of FIGS. 5 through 9.

Referring now to FIG. 1B, a flowchart of the functional steps capable of being achieved by the modular assisted visualization system 100 of FIG. 1A is illustrated. Starting at step 130 the operator turns on the power to the remote image manipulation module 112. In this exemplary embodiment the remote image manipulation module 112 is in communication with all operative units within the modular assisted visualization system 100 and controls the function of these units. From the remote image manipulation module 112 the operator may turn the power on to the clamp system (if a clamp system is included) in step 140, the camera module 110 in step 150, the light (if a light is provided) in step 160, the circular saw 106 in step 170 and the indexer 118 in step 180. At this stage if the system 100 includes the saw controller, the conveyance mechanism controller and the elevator controller mechanism, the operator turns on the power to these devices as well.

The camera module 110, in step 151, provides an image of the work area, which may be seen by the operator on the remote image manipulation module 112. The operator may select, in step 131, the size of the work piece needed that is being stored in the hopper 102. The operator makes the selection through the remote image manipulation module 112 which conveys the information to the hopper 102 and dispenses the work piece. Depending upon the hopper 102, the size available may be fixed or vary if the hopper includes multiple compartments which store different sized work pieces. Once the operator has selected the size of the work piece, in step 132 the operator uses the remote image manipulation module 112 to select the cut type, cut length and the number of same sized work pieces that will be operated upon.

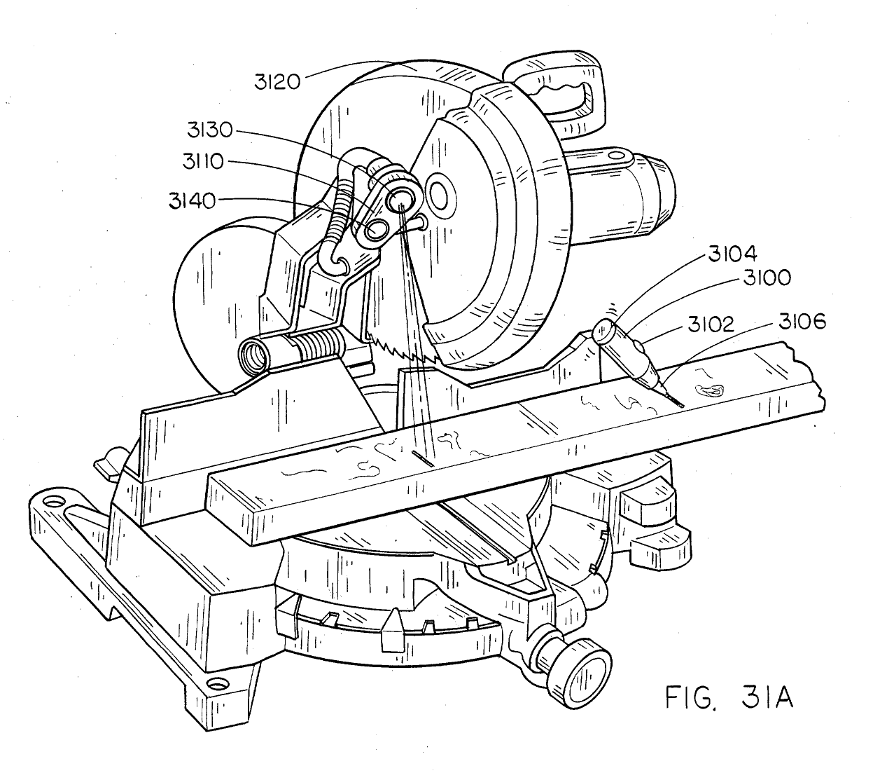

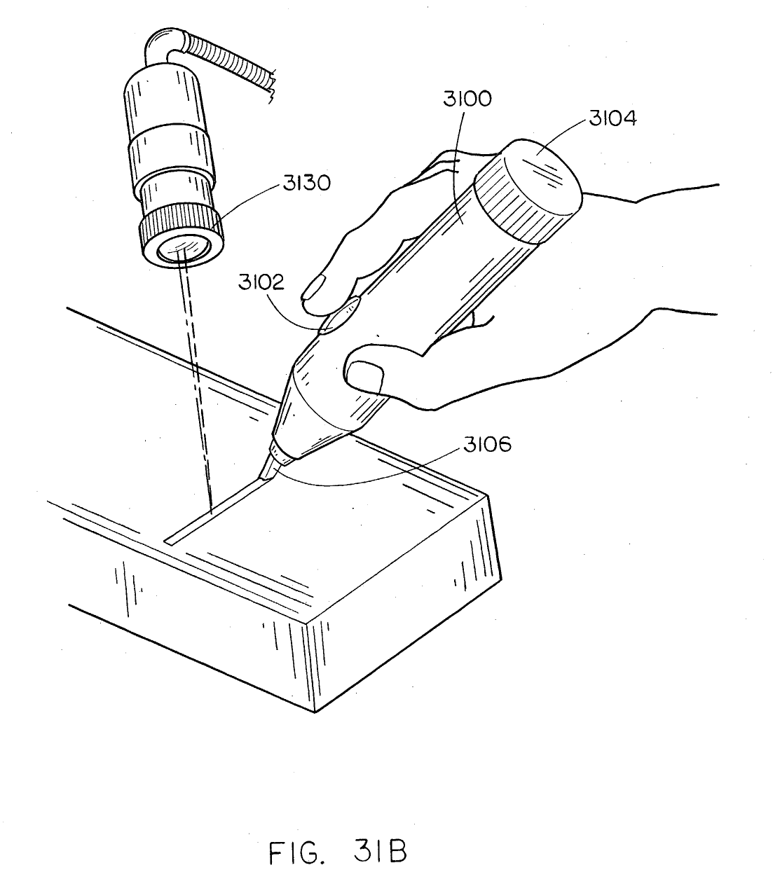

The cut length is set by the operator based upon measurement information provided by the measuring device. Preferably, the measurement information is fed into the remote image manipulation module 112, which then establishes a first mark and a second mark on the selected work piece prior to its being conveyed to the work area of the circular saw 106. In another embodiment of the present invention no visual marks may be established. The remote image manipulation module 112 may index the entire work piece length and then establish virtual mark(s) for the cut line(s) based on the measurement information provided. Alternately, the operator may manually establish the first and second marks on the work piece to establish the length of the cut. The marks may be a variety of forms so long as they are readable by the camera module 110. Thus, the marks may be a drawn line or any suitable form as may be contemplated by one of ordinary skill in the art. One alternative marking method is discussed below in FIGS. 31A through 31C.

In the present invention an indexer is connected to the hopper 102 in a location prior to the work piece entering the work area of the circular saw 106. The indexer, in communication with the remote image manipulation module 112, may mark the work piece with an indicator readable by the camera module 110.

The cut type is set by the operator entering the information into the remote image manipulation module 112, then in step 171, the circular saw 106 is set to provide that particular type of cut.

In step 181 the selected work piece is indexed into the work area of the circular saw 106. This is accomplished through use of the indexer 118, controlled by the remote image manipulation module 112. In this exemplary embodiment, the work piece has been marked with a first and a second mark to establish the length of the work piece. Once the work piece has been conveyed by the indexer 118 into the work area, the camera module 110, in step 152, locates the first mark (which may be the first edge of the work piece) on the work piece. Upon the mark being read by the camera module 110 indexing of the work piece is halted in step 182. The remote image manipulation module 112, through the camera module 110 lays down a cut line along the first mark. The operator may visually ascertain the established cut line through the image of the work area displayed upon the remote image manipulation module 112.

If the circular saw 106 includes a clamp system then the clamp system clamps the work piece in place in step 142. The operator, if the camera of the camera module 110 includes a zoom function, may get a closer look at the work piece in the work area in step 163.

Regardless of the view the operator takes of the work piece, in step 172 the circular saw is engaged to cut the work piece along the cut line established via the remote image manipulation module 112. This first cut or front edge is then viewed by the operator through the remote image manipulation module 1112. The operator may zoom in on the work piece to inspect the cut if this option is available. At step 133 the remote image manipulation module 112, asks the operator to approve or disapprove of the cut. If the operator disapproves of the cut made then, the system returns to step 132 and proceeds forward again.

If the operator approves then, in step 143, the clamp system releases the work piece and step 183 provides for the indexing of the work piece, by the conveyance mechanism 104, until in step 154 the camera module 110 locates the second mark on the work piece. Once the second mark is located, then in step 184 the indexing of the work piece is halted and through step 144 the work piece is clamped in place, as discussed above. The remote image manipulation module 112, through the camera module 110, lays down a cut line along the second mark and, in step 173, the circular saw 106 cuts the work piece along the cut line. The work piece is unclamped in step 145 and the operator may view the cut through the display on the remote image manipulation module 112 in step 165.

The operator is asked a second time to approve or disapprove of the cut made in step 134. If the operator disapproves the system returns to step 132 and proceeds forward from there. If the operator approves the remote image manipulation module 112 asks if the operator wants to shutdown the system at this time. If the operator responds by indicating not to shut down the system then the system returns to step 131 and proceeds forward from there. Such is the case if the operator has selected multiple work pieces to be cut. However, if the operator is finished then the system may be shut down and the functional capabilities, at least temporarily, are taken off line.

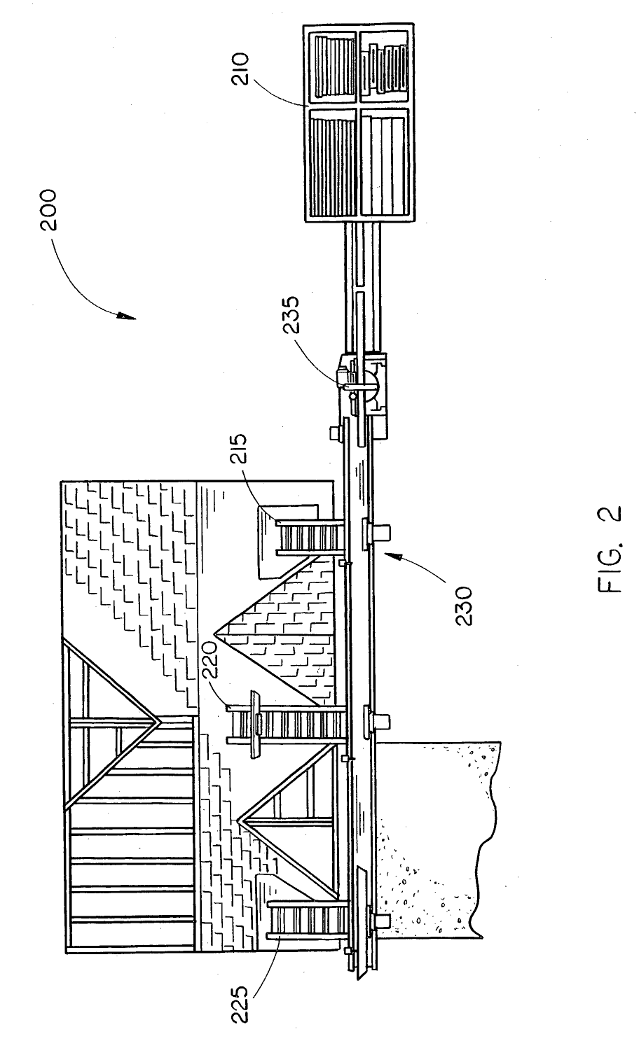

Referring now to FIG. 2, a modular assisted visualization system 200, is shown in an exemplary workplace environment. In this preferred embodiment the modular assisted visualization system 200 includes a multiple compartment hopper 210 and a first elevator 215, a second elevator 220, and a third elevator 225 within a conveyance mechanism 230, is shown. The system 200 further includes a circular saw 235. In the present embodiment, the hopper 210 is able to store and provide access to four different types of work pieces. It is understood that the arrangement of the compartments and the types of work pieces that may be placed into them may vary.

An operator of the modular assisted visualization system 200 has the capability to select any of the four different types of work pieces from the hopper 210, enable the cutting of the work piece, and delivery of the work piece. Delivery may be to any location accessed by the conveyance mechanism 230 including any location accessed by one of the three elevators connected within the conveyance mechanism. For example, the operator may be located geographically close to the saw, select and cut a work piece, and have the work piece delivered to the location reached by the third elevator 225.

An exemplary embodiment of a modular assisted visualization system 300 is shown in FIGS. 3A and 3B. The system 300 includes the image manipulation module 310, a circular saw 320, a camera module 330, a wireless remote image manipulation module 312 and a hard wired remote image manipulation module 314. The image manipulation module 310 is in communication with the circular saw 320, the camera module 330, the wireless remote image manipulation module 312 and the hard wired remote image manipulation module 314.

In one embodiment the image manipulation module 310 and the remote image manipulation modules 312 and 314 are an exemplary hardware system 350 generally representative of an information handling system sold or leased to host customers in accordance with the present invention, is shown. The hardware system 350 is controlled by a central processing system 360. The central processing system 360 includes a central processing unit such as a microprocessor or microcontroller for executing programs, performing data manipulations and controlling the tasks of the hardware system 350. Communication with the central processor is implemented through a system bus 368 for transferring information among the components of the hardware system. The bus may include a data channel for facilitating information transfer between storage and other peripheral components of the hardware system. The bus 368 further provides the set of signals required for communication with the central processing system 360 including a data bus, address bus, and control bus. The bus 368 may comprise any state of the art bus architecture according to promulgated standards, for example, industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and so on. Other components of the hardware system 350 include main memory 362 and auxiliary memory 364. The hardware system 350 may further include an auxiliary processing system 366 as required. The main memory 362 provides storage of instructions and data for programs executing on the central processing system 360. The main memory 362 is typically semiconductor-based memory such as dynamic random access memory (DRAM) and/or static random access memory (SRAM). Other semi-conductor-based memory types include, for example, synchronous dynamic random access memory (SDRAM), Rambus dynamic random access memory (RDRAM), ferroelectric random access memory (FRAM), and so on.

The auxiliary memory 364 provides storage of instructions and data that are loaded into the main memory 362 before execution. Settings of the operator for the circular saw 320 may be saved in the auxiliary memory 364 or the main memory 362. This allows the operator to set operational states that may be remembered and then repeated, such as saw stops that may be set by the operator and easily return the saw to common cut angles. Additionally, the memory allows the user to replay the last few steps before the saved location. Thus, the operator may leave a job midway through, return to it later, and be aware of what was being done before the operator left. This may aid in operator efficiency and the ability to produce more precise, repetitive cuts.

The auxiliary memory 364 may include semiconductor based memory such as read-only memory (ROM), programmable read-only memory (PROM), erasable programmable read-only memory (EPROM), electrically erasable read-only memory (EEPROM), or flash memory (block oriented memory similar to EEPROM). The auxiliary memory 364 may also include a variety of non-semiconductor-based memories, including but not limited to magnetic tape, drum, floppy disk, hard disk, optical, laser disk, compact disc read-only memory (C D-ROM), write once compact disc (CD-R), rewritable compact disc (CD-RW), digital versatile disc read-only memory (DVD-ROM), write once DVD (DVD-R), rewritable digital versatile disc (DVD-RAM), etc. Other varieties of memory devices are contemplated as well.

The hardware system 350 may optionally include an auxiliary processing system 366 which may be an auxiliary processor to manage input/output, an auxiliary processor to perform floating point mathematical operations, a digital signal processor (a special-purpose microprocessor having an architecture suitable for fast execution of signal processing algorithms), a back-end processor (a slave processor subordinate to the main processing system), an additional microprocessor or controller for dual or multiple processor systems, or a coprocessor. It will be recognized that such auxiliary processors may be discrete processors or may be built in to the main processor. The auxiliary processing system 366 may provide virtual imaging capabilities to a display system 370. This virtual imaging provides a clear image of the work piece in the work area of the saw even when debris is present in the work area.

The hardware system 350 includes the display system 370 for connecting to a display device 372, and an input/output (I/O) system 374 for connecting to one or more I/O devices 376, 378, and up to N number of I/O devices 380. The display system 370 may comprise a video display adapter having all of the components for driving the display device, including video memory, buffer, and graphics engine as desired. Video memory may be, for example, video random access memory (VRAM), synchronous graphics random access memory (SGRAM), windows random access memory (WRAM), and the like. The display device 372 may comprise a cathode ray-tube (CRT) type display such as a monitor or television, or may comprise an alternative type of display technology such as a projection-type CRT display, a liquid-crystal display (LCD) overhead projector display, an LCD display, a light-emitting diode (LED) display, a gas or plasma display, an electroluminescent display, a vacuum fluorescent display, a cathodoluminescent (field emission) display, a plasma-addressed liquid crystal (PALC) display, a high gain emissive display (HGED), and so forth.

The display device 372 may be located on a snake lockline mount allowing the user to configure the screen position in a desired location. Alternately, the display device 372 may be located on a telescoping rod. The display device 372 may be geographically separated from the hardware system 350, mounted on a wall and the like, maintaining a communicative link using a variety of mechanisms, such as serial cables, infrared, radio frequency and the like. Use of the display device 372 under the working conditions of a saw may require the screen be kept free of dust and other airborne debris or particulates. Therefore, the screen may be positively charged to repel dust, mechanically wiped, or kept clear using directed airflow.

The input/output system 374 may comprise one or more controllers or adapters for providing interface functions between the one or more I/O devices 376-380. For example, the input/output system 374 may comprise a serial port, parallel port, universal serial bus (USB) port, IEEE 1394 serial bus port, infrared port, network adapter, printer adapter, radio-frequency (RF) communications adapter, universal asynchronous receiver-transmitter (UART) port, etc., for interfacing between corresponding I/O devices such as a keyboard, mouse, trackball, touchpad, joystick, trackstick, infrared transducers, printer, modem, RF modem, bar code reader, charge-coupled device (CCD) reader, scanner, compact disc (CD), compact disc read-only memory (CD-ROM), digital versatile disc (DVD), video capture device, TV tuner card, touch screen, stylus, electroacoustic transducer, microphone, speaker, audio amplifier, another information handling system, etc. The input/output system 374 and I/O devices 376-380 may provide or receive analog or digital signals for communication between the hardware system 350 of the present invention and external devices, networks, or information sources. The input/output system 374 and I/O devices 376-380 preferably implement industry promulgated architecture standards, including Ethernet IEEE 360 standards (e.g., IEEE 360.3 for broadband and baseband networks, IEEE 360.3z for Gigabit Ethernet, IEEE 360.4 for token passing bus networks, IEEE 360.5 for token ring networks, IEEE 360.6 for metropolitan area networks, and so on), Fibre Channel, digital subscriber line (DSL), asymmetric digital subscriber line (ASDL), frame relay, integrated digital services network (ISDN), personal communications services (PCS), transmission control protocol/Internet protocol (TCP/IP), serial line Internet protocol/point to point protocol (SLIP/PPP), and so on. It is appreciated that modification or reconfiguration of the hardware system 350 of FIG. 3B by one having ordinary skill in the art does not depart from the scope or the spirit of the present invention.

Other configurations for the remote image manipulation modules 312 and 314, such as a portable wireless web pad, may be used without departing from the scope and spirit of the present invention. The number of remote image manipulation modules in communication with the image manipulation module 310 may vary according to the needs of the consumer. The modular assisted visualization system may include one, two, three, up to N number of remote image manipulation modules.

Preferably, the camera module 330 includes a camera lens 332 and a light 334. The camera module 330 provides standard video images, however, it may be configured to provide digital images. The camera lens 332 provides the visual image of the work area, which is displayed on the image manipulation module 310, the wireless remote image manipulation module 312, and the hard wired remote image manipulation module 314. The camera lens 332 may include zoom functionality, providing the operator with an enlarged view of the work area. It is understood that the configuration of the camera lens 332 and the light 334 of the camera module 330 may vary as contemplated by one of ordinary skill in the art.

The image manipulation module 310, using the camera module 330, provides the capability of establishing a visual grid or cut line on a work piece that is in a work area of the circular saw 320. The work area, as defined previously, is that area of the circular saw 320 where the work piece is placed in order for the saw to cut the work piece. In the present embodiment the work area is the platform provided by the base of the circular saw 320 where a work piece is situated to be cut. Once the work piece is in the work area it is viewed by the camera module 330. The image manipulation module 310, from the image provided by the camera module 330, may be used to establish an initial cut line. For example, the operator may place the work piece upon the work area and then by entering information into the image manipulation module 310 place the visual grid or cut line upon the work piece, through the camera module 330, and then execute a cut. Alternately, the image manipulation module 310 may be used to identify a previously marked location upon the work piece where the visual grid or cut line is to be established. In such an instance, the work piece is marked prior to being placed in the work area. Once the mark on the work piece is identified the image manipulation module 310 establishes the grid or cut line on that mark. It is contemplated that multiple grids or cut lines may be established by the image manipulation module 310 upon a single work piece or multiple work pieces.

Establishing a cut location may be accomplished by using lasers aimed at the saw blade 322. The lasers may be directed down along the plane of the blade through reflective surfaces, disposed on the saw blade 322, which create a laser line at the projected cut location. Another method may include using a virtual fence which allows the image manipulation module 310 to range find off the end of the work piece. This enables the operator to enter the desired length of the work piece into the image manipulation module 310, and then the image manipulation module 310 determines the appropriate cut position.

By using the image manipulation module 310 the operator may adjust the established grid or cut line through use of the camera module 330. The operator may move the grid or cut line along the length of the work piece or the operator may rotate the grid or cut line into a desired position. The modular assisted visualization system 300 may include two or more camera modules coupled with the circular saw 320. This provides an operator increased imaging capabilities as well as a more defined image of the work area.

The image manipulation module 310 may include a “learn” mode, which allows the operator to duplicate existing cut geometry. For example, the user places the work piece into the work area of the saw in the “learn” location, and the image manipulation module 310 calculates how to repeat the end geometry. Thus, the operator is able to repeat the exact angle of the existing cut. Additionally, the display device of the image manipulation module and the remote image manipulation modules may include a video capture functionality. The video capture enables the operator to archive video of processes and retrieve them at a later date. Thus, the operator may establish a cut process one day and then come back days later and be able to repeat the results achieved originally. This feature greatly enhances the capabilities of the operator to make precise, repetitive cuts.

In the present embodiment the circular saw 320 is a miter saw including a saw blade 322, a base 324 and an angled cut adjustment mechanism 326. The angled cut adjustment mechanism 326 is manually operated through the use of a handle 328. It is contemplated that servos may be used to provide the circular saw 320 with the angled cut capabilities. The servos may be in communication with the image manipulation module 310, allowing the operator to control the angle of cut through the modular assisted visualization system. The saw blade 322 may be removable from the circular saw 320 and differently sized blades may be inserted and utilized.

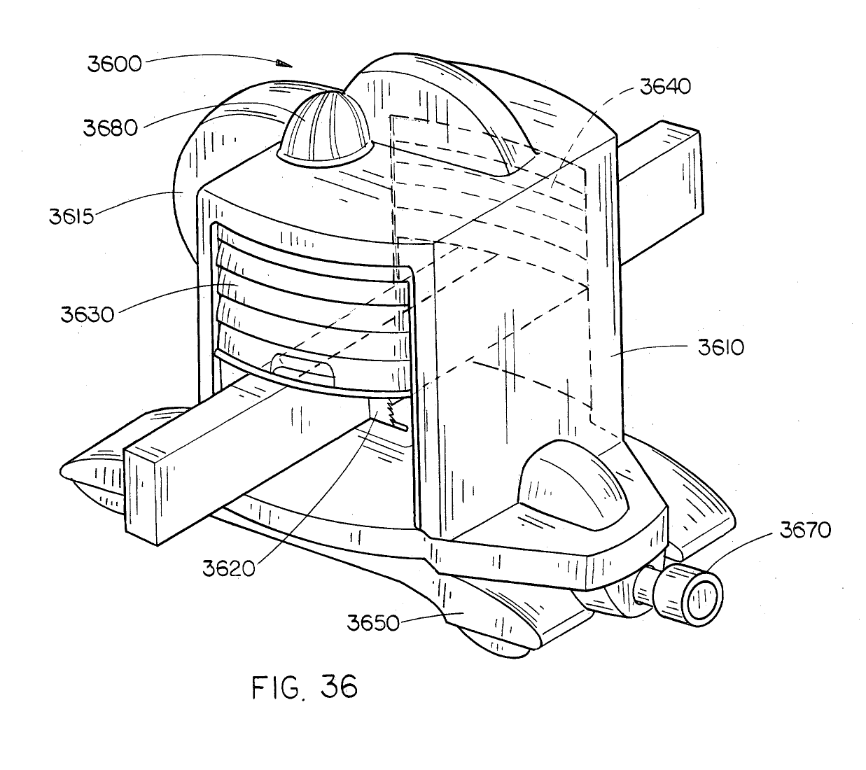

Gyroscopic controls may be integrated with the saw blade 322 to provide greater control over the blade as cuts are being made. Additionally, the saw blade 322 position, during operation, may be monitored using infrared (IR) sensors that sense the blade position from the latent heat of friction involved in cutting. This may allow the operator to make cuts upon the work piece without visual ascertainment of the cut. Such an IR sensor system may be useful in a saw system as described in FIG. 36 below. Alternately, ultrasound, electricity (conduction/resistance), or magnetic resonance methods may be used to sense blade position without departing from the scope and spirit of the present invention.

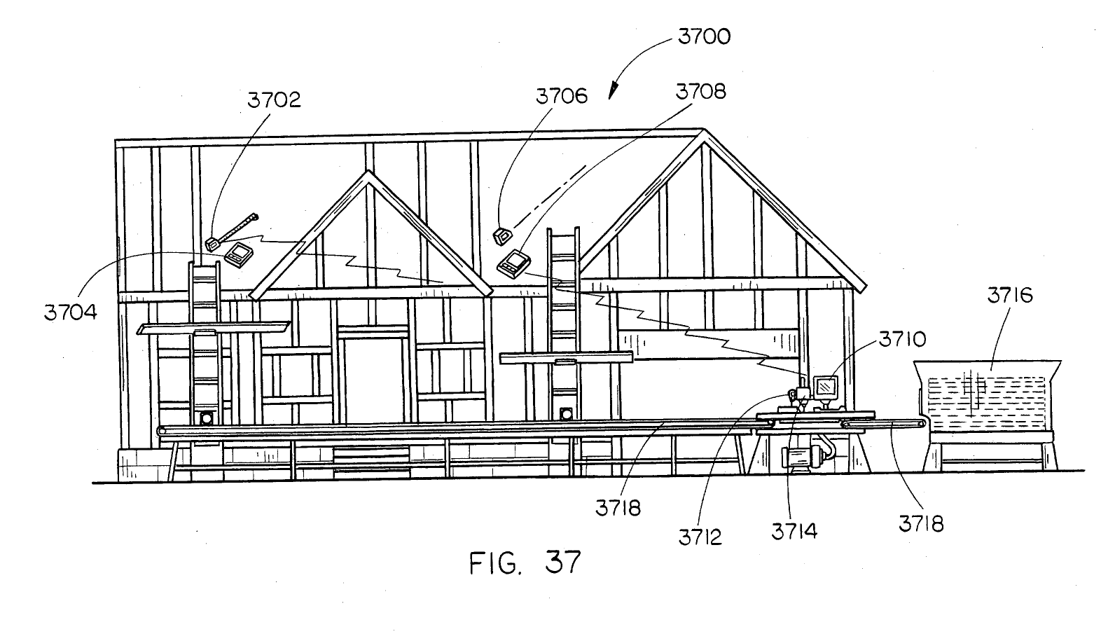

Alternately, the circular saw 320 may be a laser saw or water jet cutter (as described in FIGS. 37 through 40). Such a laser saw or water jet cutter allows the operator to create complex profiles unattainable with a standard circular saw. It is contemplated that the modular assisted visualization system may include a drill press, a sander, a shaver, a lathe or the like without departing from the scope and spirit of the present invention.

The circular saw 320 may be integrated with a dust removal system. Such a system may include a vacuum behind the blade, a downdraft table being utilized in the work area, a dust incineration system, or the like.

It is contemplated that the circular saw 320 may be enabled to provide the functionality of the image manipulation module 310 or remote image manipulation modules 312 and 314 (as described previously). The circular saw 320 may be able to connect directly to a personal computer or other information handling system, allowing the operator to use an existing display device. Additionally, the circular saw 320 may be enabled to project the image of the work area onto a wall.

Whether functionality is provided by the image manipulation module 310, the remote image manipulation modules 312 or 314, or the circular saw 320 the modular assisted visualization system has the capability to adjust for various size saw blades, camera module positions, and work piece sizes. Additionally, the modular assisted visualization system may allow the operator to connect to the internet and access a site located thereon. For example, the operator of the modular assisted visualization system may access a web site and learn how to operate the modular assisted visualization system they are using. Alternately, the operator may be able to download plans and project instructions for using the modular assisted visualization system to complete a project.

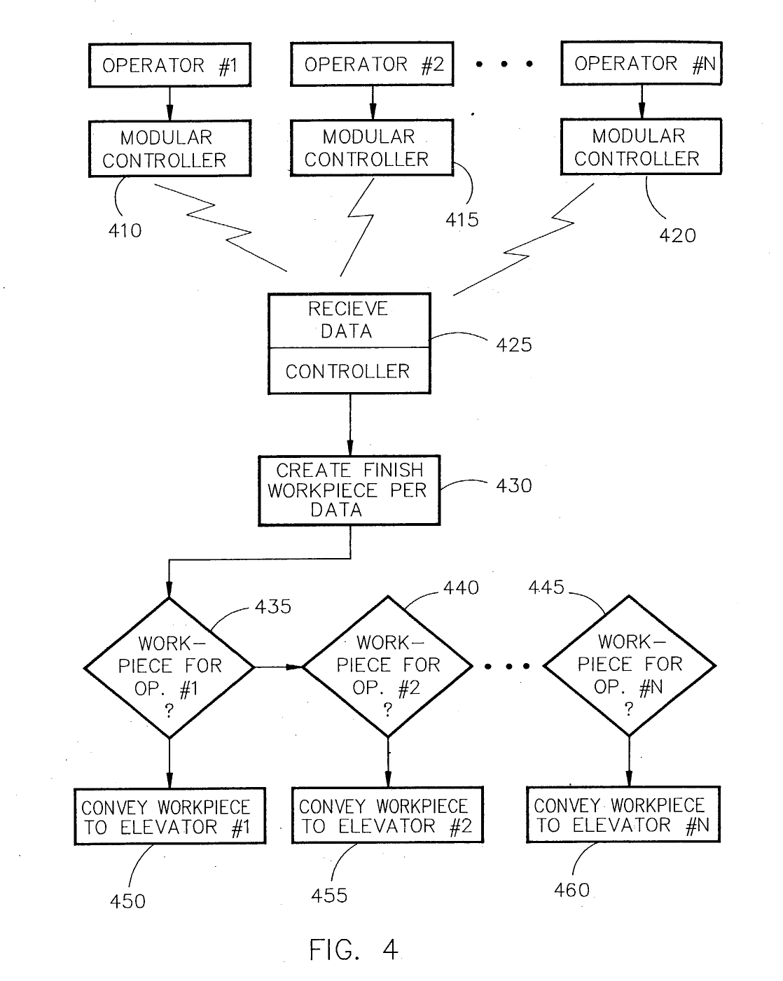

Referring now to FIG. 4, a flow chart of functional steps accomplished by the modular assisted visualization system, as described in FIGS. 3A and 3B, is shown. In the present embodiment there are N number of operators designated by Operator #1, Operator #2, through Operator #N. In step 410 Operator #1 utilizes a modular controller of the modular assisted visualization system to send data to the controller of step 425. In step 415, Operator #2 utilizes a second modular controller of the modular assisted visualization system to send data to the controller of step 425. In step 420, Operator #N utilizes an N number modular controller of the modular assisted visualization system to send data to the controller of step 425. The modular controller utilized by each operator in the system may be the wireless remote image manipulation module or the hard wired remote image manipulation module. The data once entered is then sent to the image manipulation module, which is the controller for the system. Alternately the operator may enter the data directly into the image manipulation module.

The data received by the image manipulation module is used, in step 430, to select, convey to the circular saw and cut the work piece to the desired specification. As described previously, the image manipulation module lays down a grid or cut line on the work piece in the work area using the camera module. The circular saw is then engaged upon the designated grid or cut line location and cuts the work piece.

Once cut, the image manipulation module (controller) delivers the finished product to the appropriate location. The image manipulation module maintains a list, queue or other similar data storage format of all data received from all the operators. As the data is received the image manipulation module attaches an identifier to each set of data, indicating the operator the data was received from and the location of that operator. Upon completion of the work piece, the image manipulation module determines, in steps 435, 440 and 445, the operator and operator location from the data set and proceeds, in steps 450, 455 and 460, to deliver the work piece to the appropriate location and operator.

Referring to FIGS. 5 through 9, a remote image manipulation module 500 of the present invention is shown. Remote image manipulation module 500 is a wireless remote image manipulation module, however, it is contemplated that the remote image manipulation module may be hard wired for communication between it and the image manipulation module. Other methods of communication between the remote image manipulation module and the image manipulation module may be employed, as contemplated by one of ordinary skill in the art.

The remote image manipulation module 500 includes the capability to display a wide variety of interactive displays and the image of the work area provided by the camera module. In FIG. 5 a display screen 508 is showing a MANUAL display flag 502, which indicates that the operator may proceed with a manual cut of the work piece. In alternate embodiments the display screen 508 may provide relevant information regarding a variety of applications, such as drill press coordinates, lathe coordinates, sander coordinates, and the like. The display screen further includes a cut type application 504 allowing the operator to enter the type of cut to be made and a coordinates application 506 allowing the operator to specify the length of the finished work piece. By implication, the coordinates application 506 are used in determining the location of cut(s) to be made by a saw. This screen provides the operator the capability of manually producing a desired cut using the modular assisted visualization system.

The remote image manipulation module 500, shown in FIGS. 5 through 9, includes a plurality of control mechanisms. In the present embodiment the control mechanisms are a plurality of buttons that may be depressed by the operator to select a particular application. The plurality of buttons are comprised of a first directional button 510 and a second directional button 520. These buttons allow the operator to move between the different display screens available on the remote image manipulation module 500 as well as scroll through and adjust the entries being made via the selection buttons as discussed next. Additionally, the plurality of buttons are further comprised of a first selection button 530, a second selection button 540, and a third selection button 550. These selection buttons allow an operator to select a particular application that is presented on the display screen and, if required, adjust the values of the application. A button 560, also comprising the plurality of buttons, allows an operator to select between varying configurations of the layout of the display screen. For example, the operator may select to view the final cut with the information present, as displayed in FIG. 9, or the operator may select to view the final cut on the display screen without the information present.

It is contemplated that the functionality of the plurality of buttons may be varied to include additional functional capabilities or to assign particular functions to different buttons than as shown in the exemplary embodiment. The buttons are located on the edge of the face of the remote image manipulation module 500 surrounding the display screen. The buttons may be located on the sides of the remote image manipulation module 500. Alternately, the buttons may be removed and the remote image manipulation module 500 may include a touch screen with the prompts located on the display screen and the operator simply touching the appropriate location on the screen for the application needed.

In the present embodiment the remote image manipulation module 500 has a generally square shape, like that of a palm pilot, which an operator carries and operates by hand. Other ergometric configurations are contemplated and may be employed. Alternately, the remote image manipulation module 500 may include a mounting mechanism which allows it to be coupled to another surface. For example, the mounting mechanism may be a belt loop mounting device which an operator may slide over a belt and couple the remote image manipulation module 500 to. Alternately, a work belt mount, built into a standard work belt, may provide a connection point for the transportation, utilization and storage of the remote image manipulation module 500. Other mounting schemes as contemplated by one of ordinary skill in the art may be utilized without departing from the scope and spirit of the present invention.

The display screen on the remote image manipulation module 500 may offer additional functionality to a user. As mentioned previously, the display screen may provide touch screen functionality. Furthermore, the display screen may be connected in a manner that allows it to be rotated past the plane of the module. For example, a pivot joint may be used to connect the screen to the module allowing an operator to adjust the angle of presentation of the screen. This may be particularly useful if the module is mounted upon a belt, as discussed previously, allowing the operator to view the display screen without having to remove it from the mounting. Alternately, the screen may be removable from the module allowing an operator to leave the module in one position, such as mounted to the belt of the operator, view the screen and then re-insert the screen into the module. In such an instance the screen may remain in communication with the module utilizing a variety of communication methods, such as cable wire, wireless, infrared, and the like. If a hard wire connection is maintained between the screen and the module then a retraction spool is placed in the module to store the wire when the screen is inserted in the module.

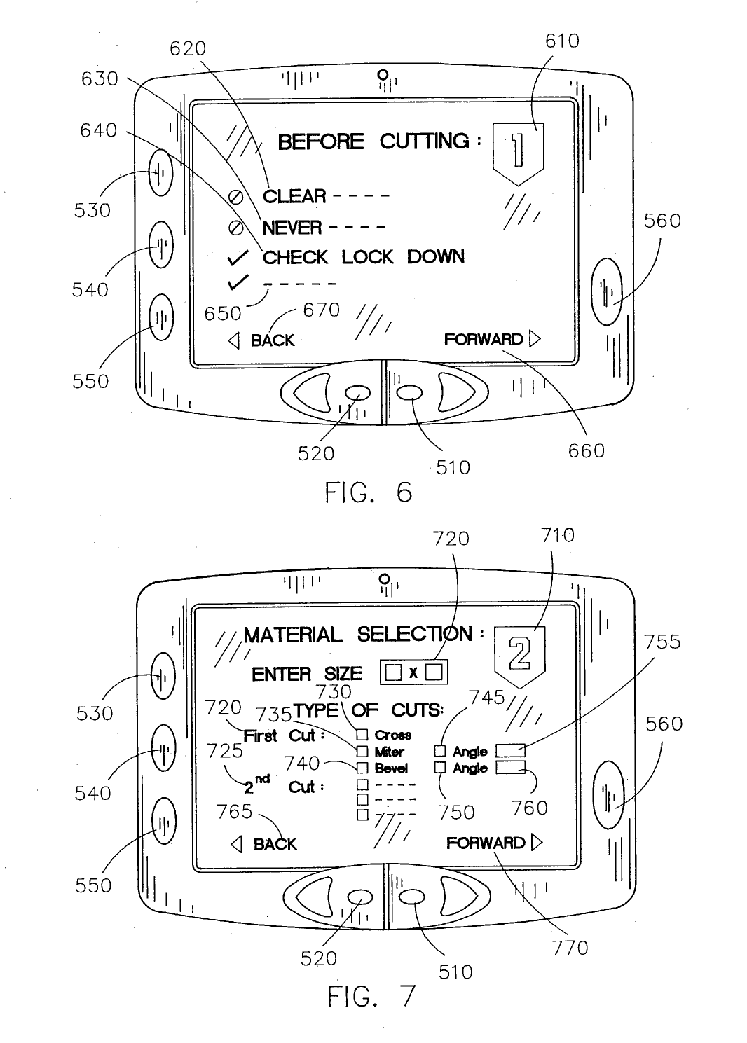

FIGS. 6 through 9 show a series of interactive displays that are presented, on the remote image manipulation module screen, to an operator in order to guide the operator through the necessary steps in executing a cut upon a work piece. In FIG. 6 the operator is presented with an exemplary pre-cut checklist. A flag 610 with the number one, denotes this first step as the BEFORE CUTTING screen. The particular items on the checklist presented in FIG. 6 may vary according to the particular needs of the operator. The present embodiment includes a “Clear” application 620, a “Never” application 630, a Check Lock Down application 640 and provides for an operator mandated entry in application 650. The Clear application 620 and the Never application 630 also allows the operator to set the system according to operator mandated specifications. The software which presents this display may provide multiple pre-cut checklist variations from which the operator may select. Upon entry of information the operator may select a forward application 660 to proceed to the next step shown in FIG. 7. The operator at any time may select a back application 670 and return to a previous screen.

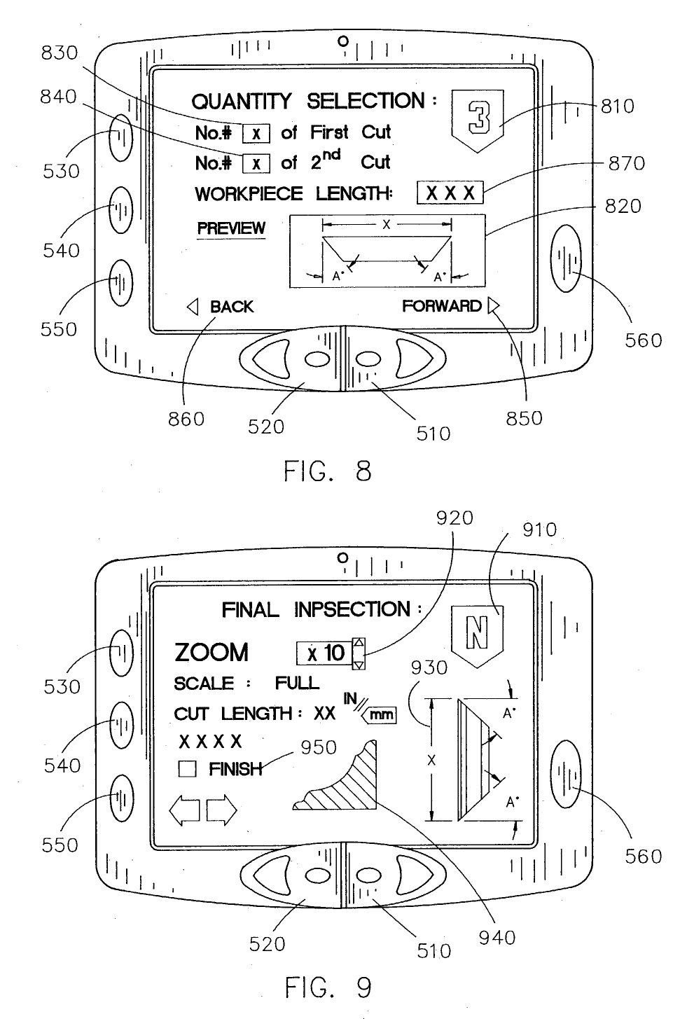

In FIG. 7, the MATERIAL SELECTION screen denoted by a flag 710 with the number two, the operator is presented with a display screen asking the operator to enter the size of the work piece in a enter size application box 715 and the type of cut to be executed in a first cut selection area 720 and a second cut selection area 725. It is understood that both the first and second cut data entry selections may be identical to or different from one another. Further, the data entry configurations and selections may be varied from the exemplary embodiment shown without departing from the scope and spirit of the present invention. The number of cuts may be adjusted by the operator to allow them to make as many cuts as they need. In the first cut selection area 720 the operator may select a cross cut in a cross cut application box 730, a miter cut in a miter cut application box 735 or a bevel cut in a bevel cut application box 740. As shown, if an operator selects either the miter type cut or the bevel type cut then, the display screen asks them to select the angle application boxes 745 or 750, respectively, and then enter the angle of the cut, in application boxes 755 or 760, respectively. As previously discussed, the operator may at any time select a back application 765 to return to a previous screen or after entering the requested information the operator may select a forward application 770 to proceed to the next step, shown in FIG. 8.

The QUANTITY SELECTION screen, denoted by a flag 810 with the number three, is shown in FIG. 8. The operator is asked to enter the total number of first cuts in a first cut application box 830 and the total number of second cuts in second cut application box 840. Additionally, the operator is asked to enter the total length of the finished work piece in a workpiece length application box 870. The operator is also given a preview display 820 of the cuts to be performed, the angles of the cuts to be performed, and what the finished work piece will look like according to the data entered by the operator. If the operator is satisfied that the preview display is what is desired for a finished product, then the operator selects a forward application 850 and the system begins to perform the required cuts on the desired work piece(s). Again, the operator has the choice to return to a previous screen by selecting a back application 860.

After each work piece is cut according to the data provided, the operator is presented with a FINAL INSPECTION display screen, as shown in FIG. 9. A flag 910 accompanies this display and is given an N designation to represent that the number of displays may vary according to the operator, up to N possibilities. Utilizing a zoom application 920 the operator is given the ability to zoom in on the view of the work piece provided by the camera module to the remote image manipulation module. The operator has the scale size identified of the view being presented as well as a view 930 of the total cut length of the finished work piece. Another display 940 gives the operator a side elevation view of the cut work piece. The images shown are exemplary and may be varied as contemplated by one of ordinary skill in the art. The operator is then given the choice to approve or disapprove of the finished work piece by selecting a finish application 950 shown on the screen.

If the operator does select finish, then the system removes the finished work piece from the work area where it is being viewed and proceeds to deliver the work piece to the specified location. The operator then selects the forward application which identifies to the system to begin checking the entered data to determine if another work piece is required and if so to begin the process of shaping the work piece according to the specifications provided. If the system determines that no other work pieces are required then, the system will shut down after delivering the finished work piece. The FINAL INSPECTION display screen is presented to the operator after completion of cutting upon each work piece.

If the operator disapproves of the finished work piece, then finish is not selected and the operator may select the back application. This action informs the system that the finished work piece is discarded and a new work piece selected. The remote image manipulation module 500 returns the operator to the MATERIAL SELECTION display screen, of FIG. 7, and asks the operator to proceed forward by entering new data. It is to be understood that the displays presented in FIGS. 5 through 9 are exemplary and may vary as directed by an operator of the remote image manipulation module 500 or others.

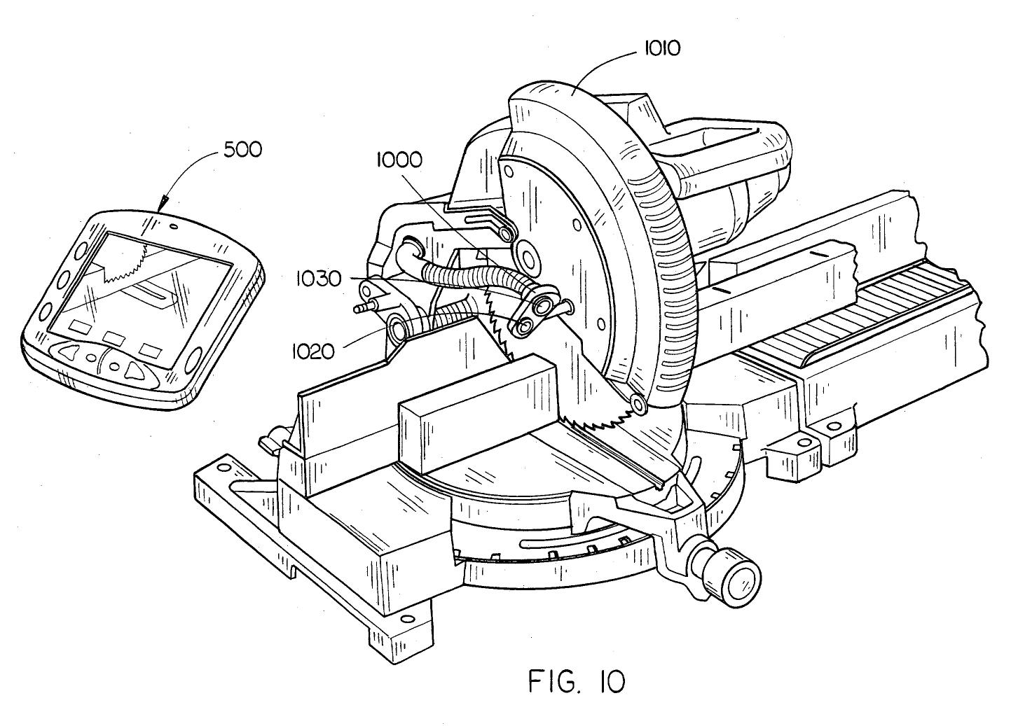

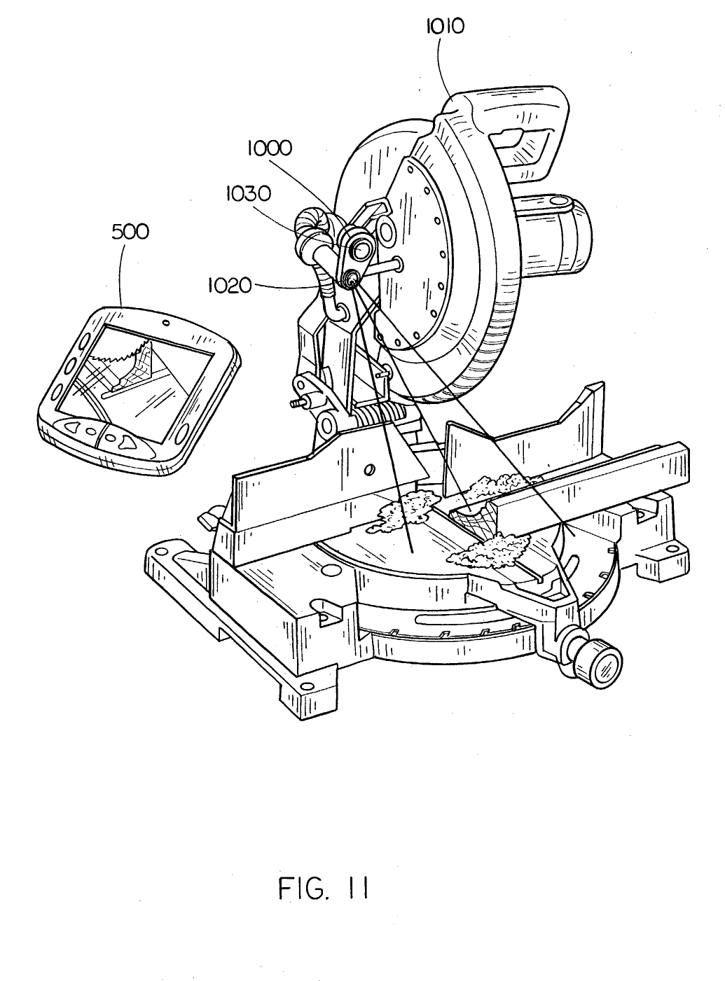

Referring to FIGS. 10 through 12, the remote image manipulation module 500 displaying the image, of the work area of a circular saw 1010, provided by a camera module 1000, is shown. The camera module 1000 is coupled to the circular saw 1010. As the circular saw 1010 engages in cutting the work piece, the camera module 1000 gives the operator a view of the work being performed in the work area.

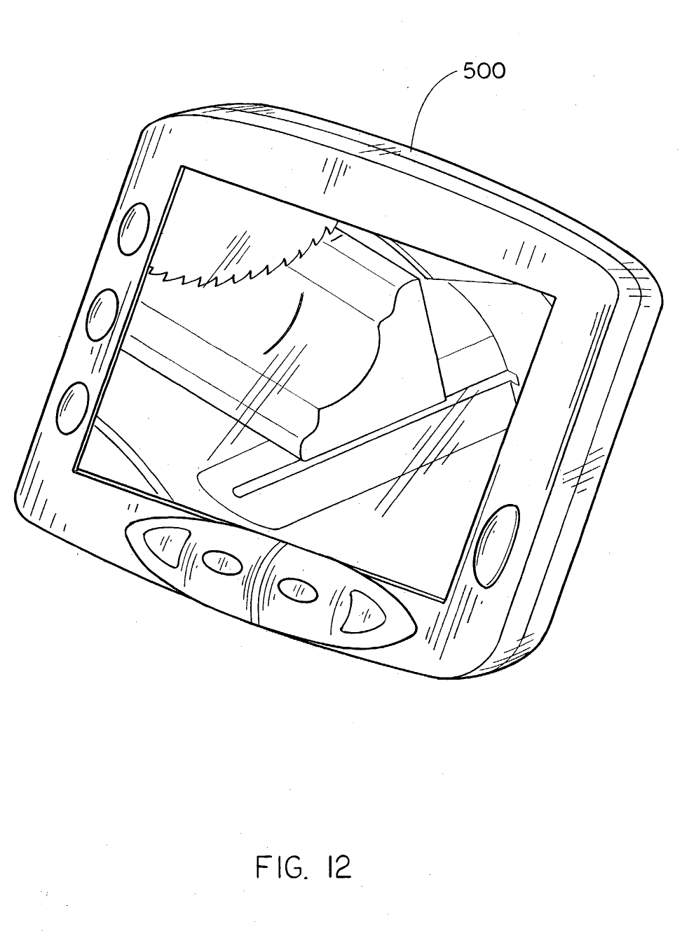

FIG. 11 shows the same system as shown in FIG. 10, except the circular saw 1010 has finished cutting the work piece and has been lifted from the work area. The remote image manipulation module 500 includes a video image enhancer feature which allows the video image, provided by the camera module 1000, to be displayed as a virtual image on the remote image manipulation module 500. This virtual image, seen by the operator on the display screen of the remote image manipulation module, provides a picture of the cut work piece that is free of debris which may interfere with the viewing of the work piece by the operator. Such a video image enhancer feature enables the operator to ensure that the cuts made meet the specifications required. It is contemplated that the video image enhancer capability may be included in the image manipulation module or other operational module of the modular assisted visualization system. FIG. 12 provides an isolated view of the remote image manipulation module 500, shown in FIG. 11. The display screen provides the operator with an unobstructed virtual image of the work area after the circular saw 1010 has finished cutting the work piece.

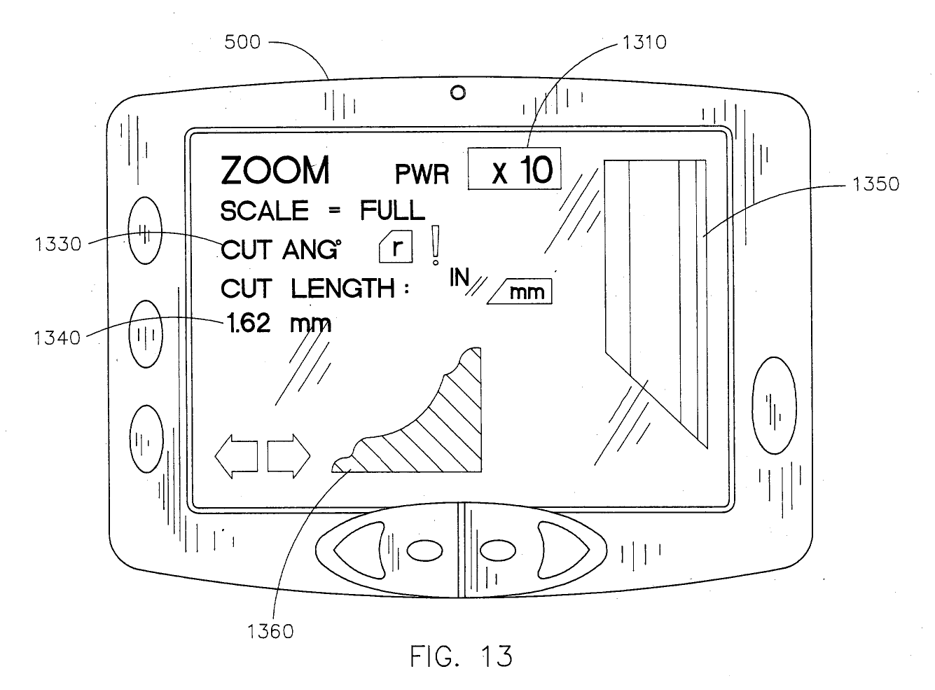

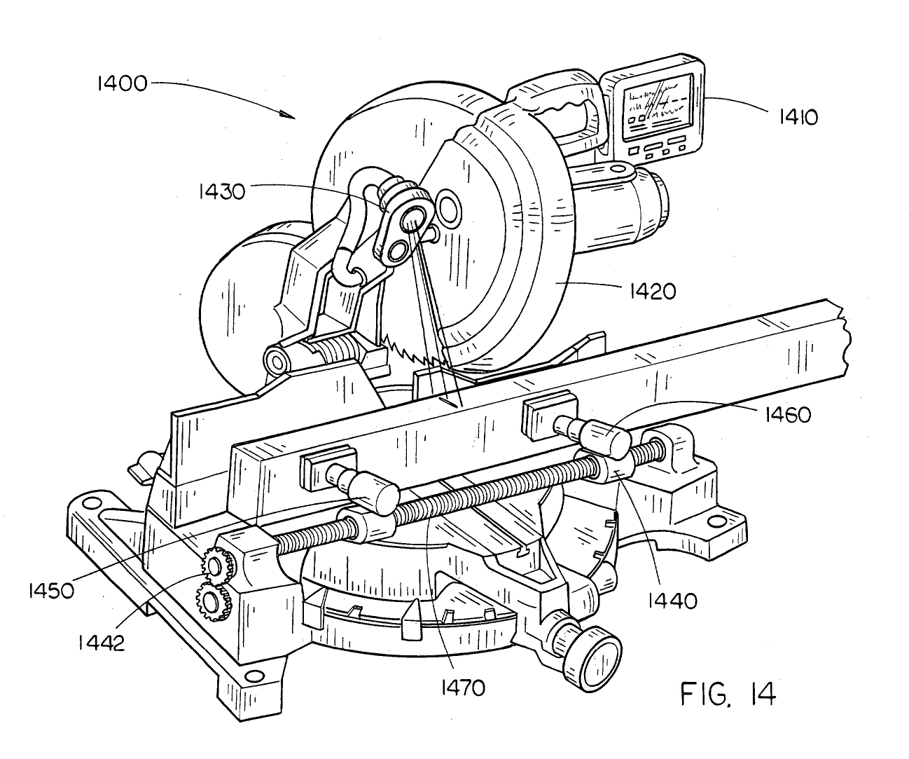

FIG. 13 is an illustration of the remote image manipulation module 500, with the display screen providing the operator a final inspection display, similar to that shown in FIG. 9. A zoom application is indicated by a power box 1310 as being to the power of 10. The zoom application may include the ability to provide a variety of zoom powers as contemplated by one of ordinary skill in the art. The scale application is designated as full and a cut angle application 1330 provides verification of the cut angle produced. The cut length application provides a readout 1340 of the total cut length of the work piece as well as a visual display 1350 of the work piece. A side elevation display 1360 is provided of the finished work piece, similar to that described previously in FIG. 9.

Referring to FIGS. 14 through 17, a system 1400 is shown including a saw controller 1410, a circular saw 1420, a camera module 1430 and a clamping mechanism 1440. The saw controller 1410 may be added to a modular assisted visualization system, such as that shown in FIG. 3, to control the operation of the circular saw 1420. The saw controller 1410 is in communication with the camera module 1430. It is contemplated that the saw controller 1410 may be in direct communication with an image manipulation module and a remote image manipulation module such as that shown in the modular assisted visualization system 300 of FIG. 3.

The clamping mechanism 1440 is mounted to the circular saw 1410 and provides a first arm 1450 and a second arm 1460 to engage the work piece within the work area. The first and second arms are comprised of a retraction/extension system to allow the arms to engage and disengage the work piece. The retraction/extension system may be screw drive, hydraulic or the like.

The first and second arms are coupled to a threaded support bar 1470 which couples with a first control mechanism 1442 and a second control mechanism 1444 at the opposite end. Using the first and second control mechanisms, the threaded support bar 1470 allows the arms to be repositioned as needed. As shown in FIG. 15, when the arms are engaged with the work piece they may adjust the position of the work piece in the work area by using the threaded support bar 1470.

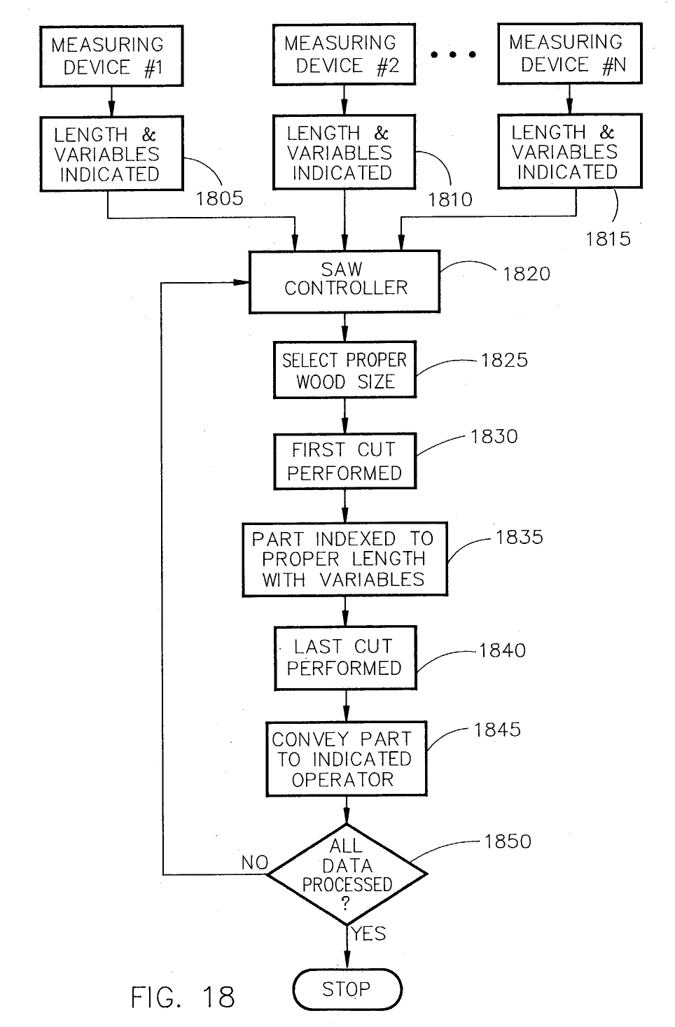

The saw controller 1410 is in control of the clamping mechanism 1440 and may adjust the position of the arms using the threaded support bar 1470, as well as, engage the arms with and disengage the arms from the work piece. FIG. 17 shows a clamping mechanism controller 1710 coupled with the circular saw 1420. The clamping mechanism controller 1710 provides the operator direct control over the clamping mechanism 1440 allowing the operator to secure or release the work piece as well as adjust the position of the work piece once secured by the clamping mechanism 1440. Alternately, the clamping mechanism controller 1710 may be in communication with the saw controller 1410 enabling the operator to control the clamping mechanism from the saw controller. The clamping mechanism controller 1710 may be in communication with an image manipulation module or a remote image manipulation module of a modular assisted visualization system. The operator may then control the clamping mechanism by using either of these devices. It is contemplated that the clamping mechanism controller 1710 may be a handheld device operable from a geographically remote location in relation to the clamping mechanism 1440.

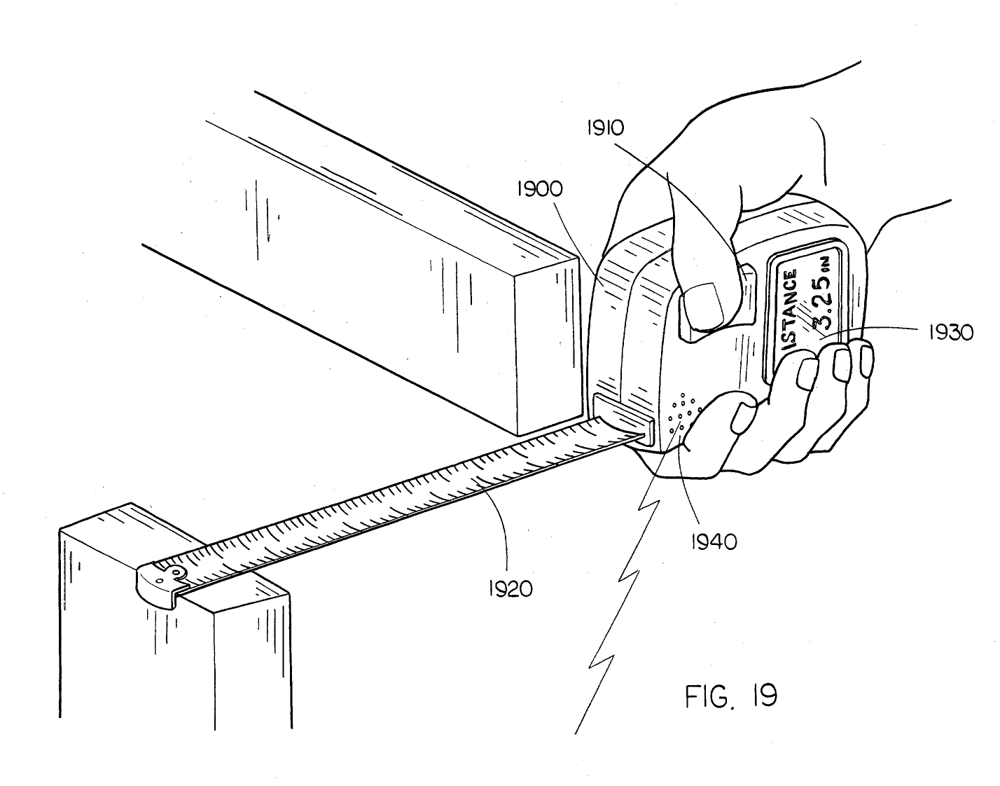

Referring to FIG. 18 the functional steps that may be accomplished by the modular assisted visualization system, using a measuring device and a saw controller, are shown. The number of measuring devices employed may vary as illustrated by the present embodiment which shows a measuring device #1, a measuring device #2 and a measuring device #N, where N may be any number of measuring devices. When employing a measuring device within the modular assisted visualization system the first step, regardless of the number of measuring devices used, is to ascertain the length and variables needed. This ascertainment is accomplished in step 1805 for measuring device #1, 1810 for measuring device #2, and 1815 for measuring device #N. All data established by the measuring devices in steps 1805, 1810, and 1815 are then communicated to the saw controller in step 1820. The saw controller, in this embodiment of the present invention, is acting as a communications hub to which the measuring devices are relaying the information to. Alternate communication routes may be employed, such as having the measuring devices relay the information to the remote image manipulation module which then relays it to the image manipulation module which then relays it to the saw controller. Another option may include having the measuring device relay the information directly to the image manipulation module and then on to the saw controller or having the measuring device relay the information to the remote image manipulation module which then relays it directly to the saw controller. The insertion or removal of the different modules in the modular assisted visualization system does not diminish the systems capabilities.

When the saw controller has received the measuring device data in step 1820, the system proceeds forward by selecting the proper wood size in step 1825. With the proper wood size selected the work piece is moved into the work area and a first cut is performed in step 1830. The cut work piece is then indexed to the proper length according to the data provided by the measuring device in step 1835 and a second cut is performed upon the work piece in step 1840. After the work piece is finished being cut it is then conveyed to the indicated operator in step 1845. After the work piece is moved out of the work area the system, in step 1850, determines if all the data provided has been processed. If there remains unprocessed data the system returns to step 1820 and proceeds forward. If the system is free of any unprocessed data then the system terminates its current operation.

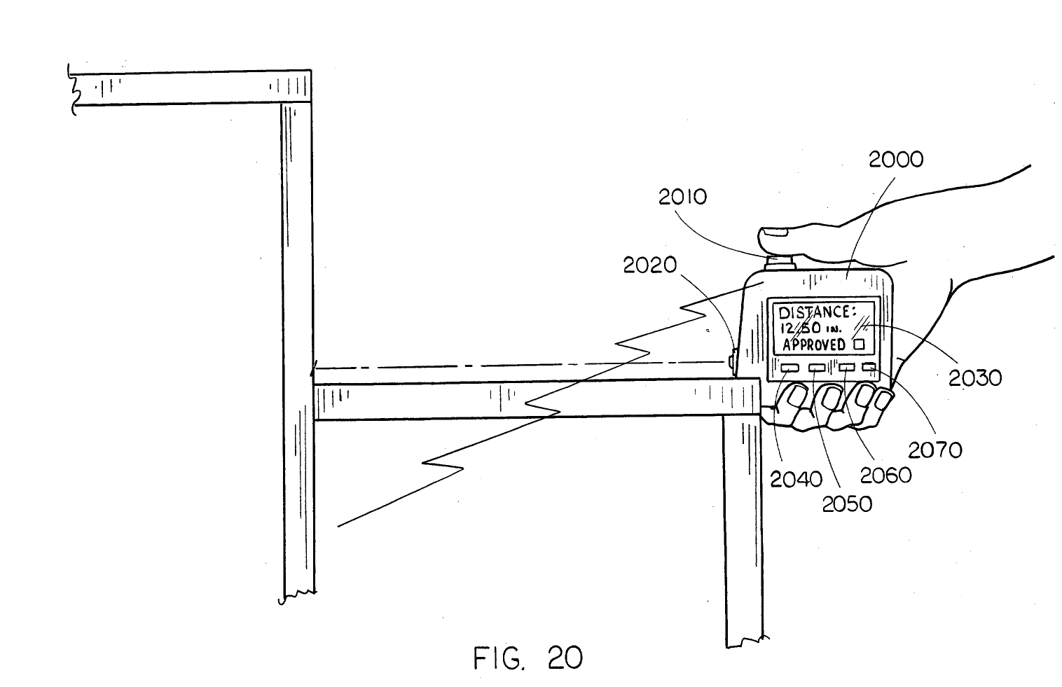

Referring to FIGS. 19 and 20, exemplary embodiments of a measuring device, which may be employed within the modular assisted visualization system, are shown. In FIG. 19, a tape measure 1900 includes a transmission switch 1910, a measuring tape 1920, a display screen 1930, and a transmitter 1940. The distance is measured by the measuring tape 1920 and displayed on the display screen 1930. Preferably, the display screen 1930 is turned on when the measuring tape 1920 is deployed out from the tape measure 1900. Alternately, an on/off switch may be included upon the tape measure 1900 to control the functioning of the display screen 1930.

If the operator agrees that the distance displayed is correct, then the operator presses the transmission switch 1910 and the distance information is electronically transmitted via the transmitter 1940 to another module within the modular assisted visualization system. The transmission switch 1910 is a two position switch, however, other switch configurations as may be contemplated by one of ordinary skill in the art may be employed. The module which receives the electronic transmission from the measuring device may be the remote image manipulation module, the image manipulation module, or the saw controller (if one is included in the system).

In FIG. 20, an electronic measuring device 2000 is shown. In the present embodiment the electronic measuring device includes a switch 2010, an electronic eye mechanism 2020 for determining distances, and a display screen 2030 for displaying distances measured. The display screen may be able to present a range of applications, for example, in the present embodiment the display screen includes an application box that the operator may select once the operator approves of the distance reading. Further, the electronic measuring device includes a first selection button 2040, a second selection button 2050, a third selection button 2060, and a fourth selection button 2070. These buttons may enable the operator to access the range of applications available and make selections based on the current need.

In the current embodiment the switch 2010, once depressed by the operator, initiates an electronic transmission from the electronic eye mechanism 2020. This transmission enables the measuring device 2000 to determine the distance from its position to a second position designated by the operator. After the measuring device 2000 establishes the distance it transmits this information to a module of the modular assisted visualization system as described above for FIG. 19. Alternately, the electronic measuring device 2000 may be enabled to transmit the distance data upon the operator selecting the approved application using at least one of the selection buttons.

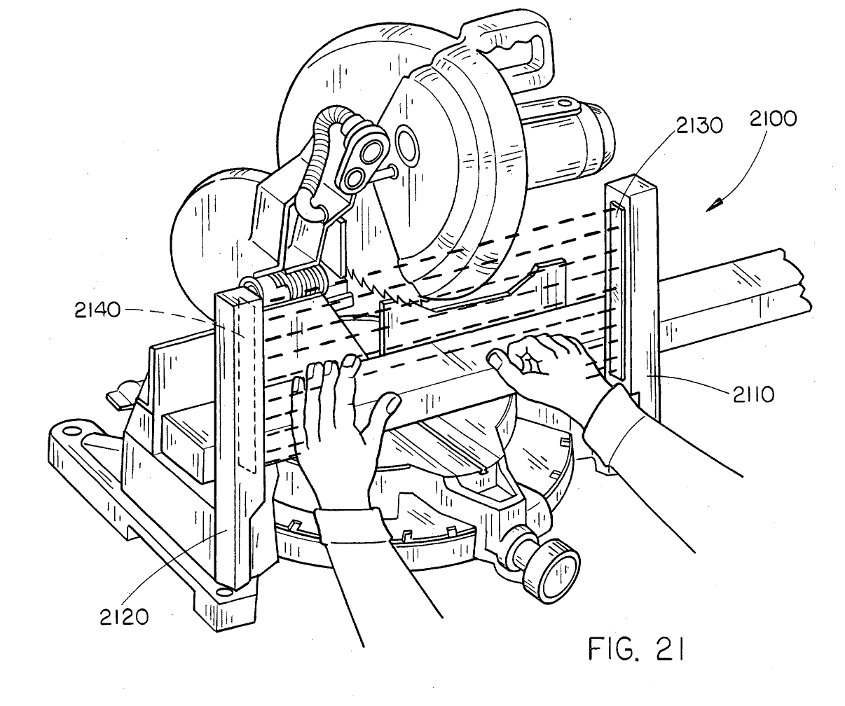

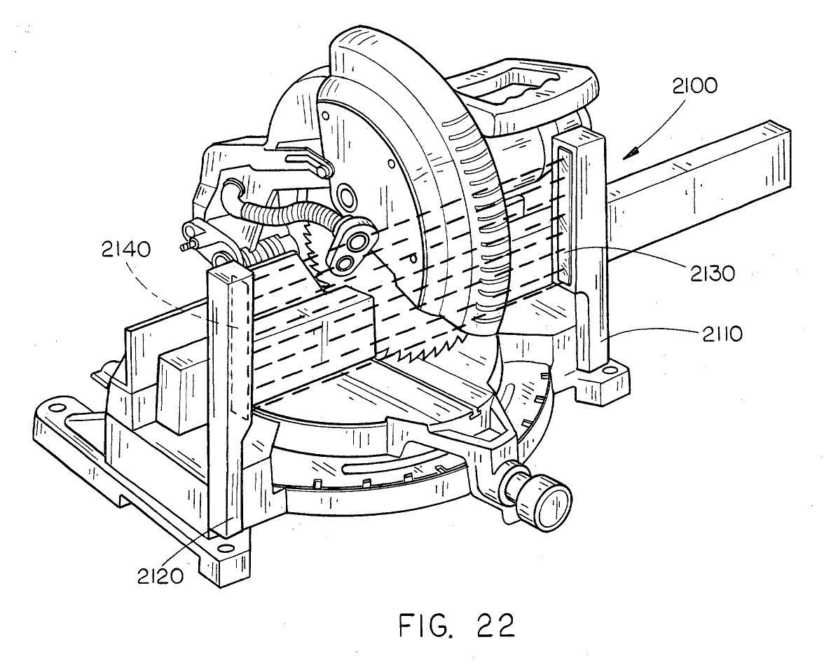

A circular saw coupled with a safety guard protection system 2100 is shown in FIGS. 21 and 22. The safety guard protection system 2100 includes a first sensor post 2110 and a second sensor post 2120. The first and second sensor posts are coupled to the base of the circular saw in a vertical orientation. The coupling of the sensors may allow the operator to adjust the location of the sensor posts relative to the saw blade in order to accommodate a variety of differently sized work pieces. The first sensor post 2110 includes a first sensor panel 2130 and the second sensor post 2120 includes a second sensor panel 2140. The sensors face each other across the base of the circular saw directly in front of the work area accessed by the saw blade.

The sensor panels and sensor posts are located in a position to allow the saw blade to cut the work piece, as shown in FIG. 22, without triggering the safety guard protection system. With the work piece in the work area, as shown in FIG. 21, an operator who places a part of themselves or another foreign object between the two sensors will trigger the safety guard protection system 2100 and the saw blade is shut down. The sensor panels may employ an electronic system, laser system, and the like. Alternately, a shield may be coupled to the circular saw that provides a physical barrier between the operator and a working saw blade. Other safety mechanisms, as contemplated by one of ordinary skill in the art may be employed without departing from the scope and spirit of the present invention.

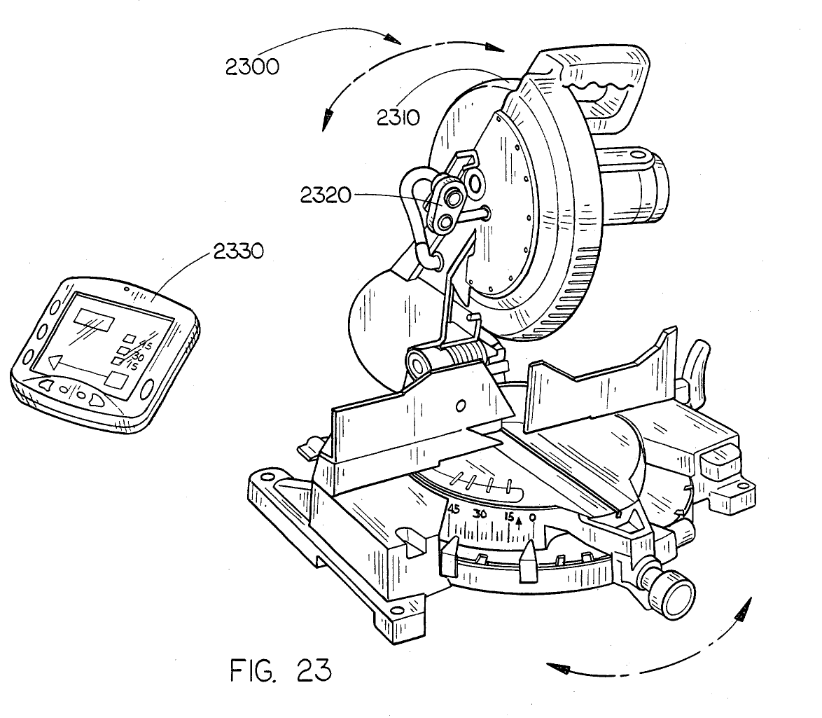

Referring to FIG. 23, a modular assisted visualization system 2300 includes a miter saw 2310, a camera module 2320 and a remote image manipulation module 2330. The operator of the system 2300 makes an angle of cut selection on the remote image manipulation module 2330, as previously described in FIG. 7. In the present embodiment the remote image manipulation module 2330 is in communication with the miter saw 2310. Therefore, the remote image manipulation module 2330 controls the function of the miter saw 2310. In alternate embodiments the information may be relayed to the miter saw 2310, either through an image manipulation module or a saw controller, and the miter saw 2310 cut angle is set. The camera module 2320 provides the same video image functionality as has been described previously in FIGS. 1A, 1B, 10 and 11.

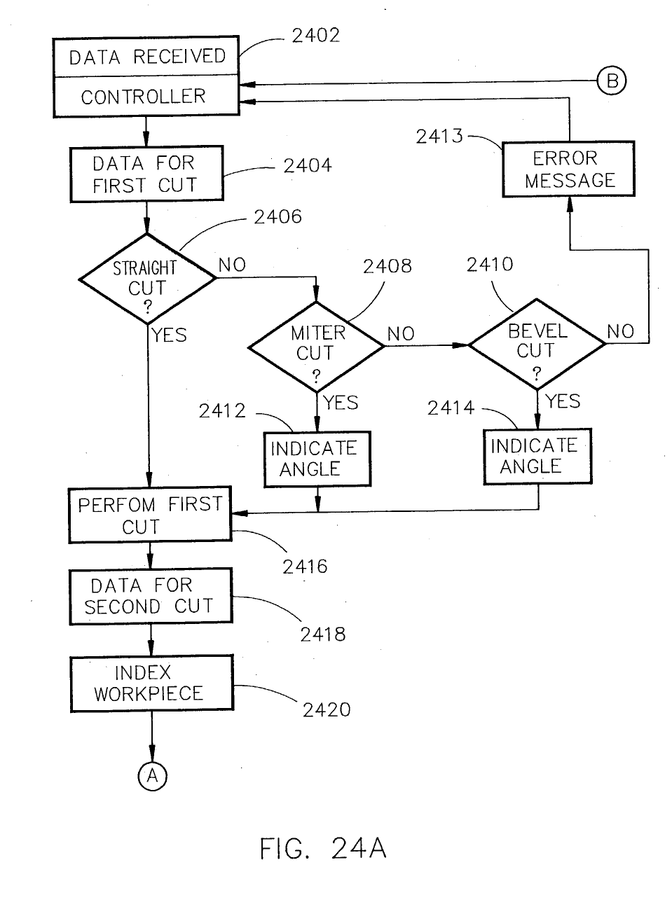

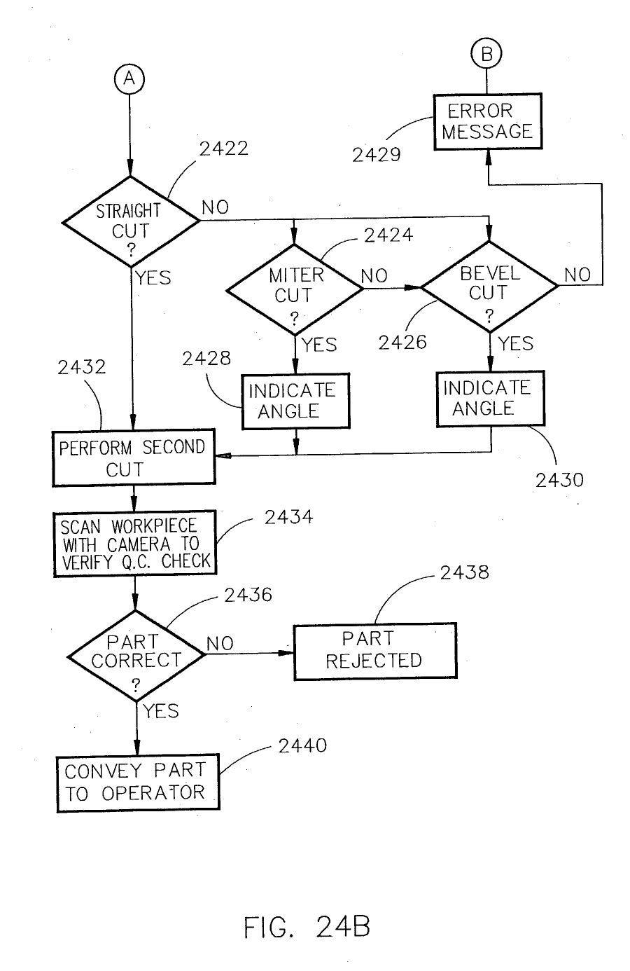

A flowchart of the functional steps that may be accomplished by the modular assisted visualization system 2300, as described in FIG. 23, is shown in FIGS. 24A and 24B. In step 2402 the data from the remote image manipulation module 2330 is received by a controller which is either the saw controller or the image manipulation module. The controller, in step 2404, isolates the data for the first cut and determines in step 2406 if the first cut is to be a straight cut. If the cut is to be a straight cut then, the controller relays all data to the miter saw 2310 and performs the first cut in step 2416.

If the controller, in step 2406, determines that the first cut is not a straight cut then, in step 2408 the controller determines if the first cut is to be a miter cut. If step 2408 determines it is a miter cut then, in step 2412, the angle of the miter cut is indicated to the miter saw and the system proceeds to step 2416 and performs the first cut. If step 2408 determines it is not a miter cut then, in step 2410, the controller determines if the first cut is a bevel cut. If step 2410 determines it is a bevel cut then, in step 2414, the angle of the bevel cut is indicated to the miter saw and the system proceeds to step 2416 and performs the first cut. If step 2410 determines that it is not a bevel cut then, in step 2413, an error message is generated and the system returns to step 2402 to re-verify the data.

After the first cut is performed in step 2416 the data for the second cut is retrieved in step 2418. Using the data for the second cut the work piece is indexed to the appropriate length in step 2420 for the second cut. In step 2422 the controller determines if the second cut is to be a straight cut. If the cut is to be a straight cut then the controller relays all data to the miter saw 2310 and performs the second cut in step 2432.

If the controller, in step 2422, determines that the first cut is not a straight cut then, in step 2424 the controller determines if the first cut is to be a miter cut. If step 2424 determines it is a miter cut then, in step 2428, the angle of the miter cut is indicated to the miter saw and the system proceeds to step 2432 and performs the first cut. If step 2424 determines it is not a miter cut then, in step 2426, the controller determines if the first cut is a bevel cut. If step 2426 determines it is a bevel cut then, in step 2430, the angle of the bevel cut is indicated to the miter saw and the system proceeds to step 2432 and performs the first cut. If step 2426 determines that it is not a bevel cut then, in step 2429, an error message is generated and the system returns to step 2402 to re-verify the data.

After the second cut is performed, in step 2432, the system scans the work piece with the camera module 2320 to verify the quality of the cut performed in step 2434. The system then asks the operator, through a display on the remote image manipulation module 2330, to verify the part is correct in step 2436. If the operator disapproves of the work piece then, the part is rejected in step 2438. If the operator approves of the work piece then, the part is conveyed to the operator in step 2440.

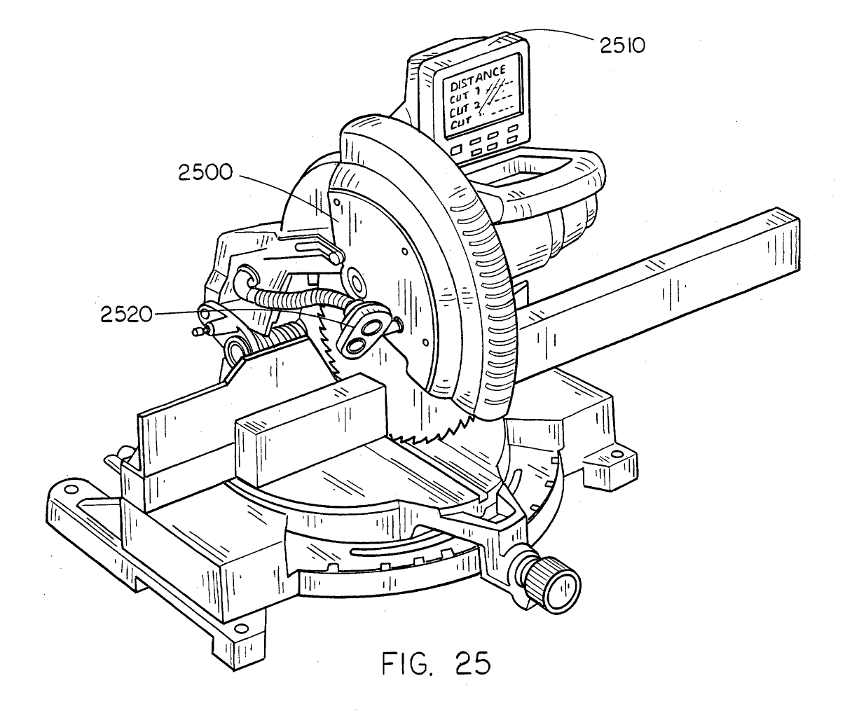

Referring to FIG. 25, a circular saw 2500, is shown engaged on a work piece. The circular saw 2500 is coupled with a camera module 2520 and a saw controller 2510. The saw controller 2510 may receive data from an operator via a remote image manipulation module, such as that shown in FIG. 23, and then direct the circular saw 2500, as shown in FIGS. 24A and 24B, to perform the required tasks according to the data received. The saw controller 2510 is coupled to the miter saw 2310, however, the saw controller 2510 may be removable from the circular saw 2500 and still maintain control over the functioning of the saw.

Alternately, the saw controller 2510 may be in communication with an image manipulation module. The image manipulation module may relay the information received from the remote image manipulation module to the saw controller 2510 for execution of the circular saw 2500 upon a work piece.

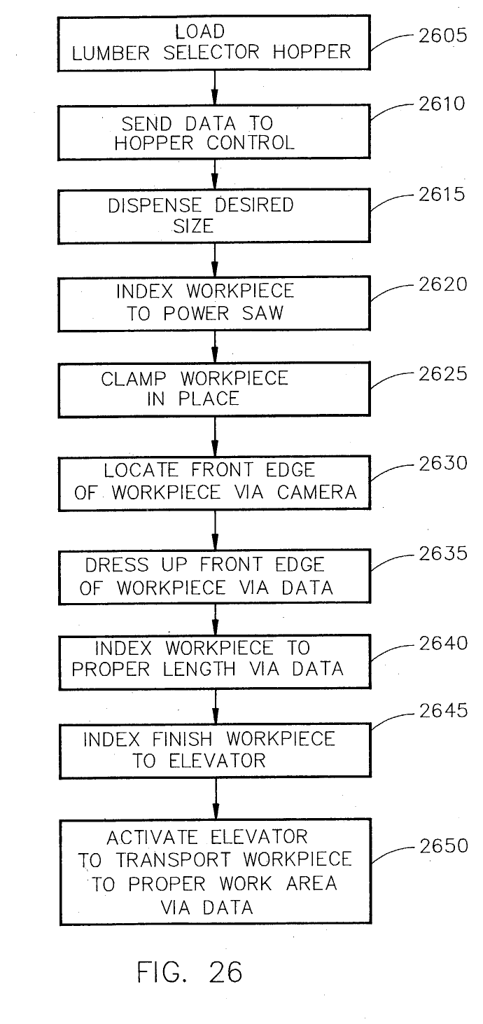

Referring to FIG. 26, a flowchart of the functional steps that may be accomplished by a multi-compartment hopper, which may be included within a system that utilizes the modular assisted visualization system, is shown. The first step 2605 is to load the compartments of the hopper with lumber. The number of different types of lumber available to the operator will depend on the number of different compartments available within the hopper. The operator, in step 2610, sends data to a hopper controller. This may be accomplished by using a remote image manipulation module, a saw controller or an image manipulation module depending on which of these modular devices is in communication with the hopper controller.

Upon receiving the data, the hopper controller dispenses the desired lumber from the hopper in step 2615. The work piece is indexed (conveyed) to the power saw (circular saw) in step 2620 and clamped in place by the clamping mechanism in step 2625. The front edge of the work piece or a marker is located via the camera module in step 2630. Once the front edge or the marker is located then, in step 2635, the modular assisted visualization system lays down the grid or cut line on the work piece to prepare a cut according to the data received from the operator. After a first cut is made in accordance with the grid or cut line established in step 2635 the work piece is indexed the proper length to establish the location of the second cut in step 2640. Again, the modular assisted visualization system lays down a grid or cut line on the work piece to prepare for the second cut in accordance with the data received from the operator.

After the second cut is made the system, in step 2645, indexes the work piece to the proper location specified by the operator for delivery of the finished product. This may involve utilizing an elevator device that is a part of the conveyance mechanism in order to reach the desired location. Once the work piece is conveyed to the elevator then, in step 2650, the elevator is activated and the work piece is transported to the proper location. It is understood that the conveyance mechanism may include no elevators or a plurality of elevators. Additionally, multiple elevators may be coupled together to provide delivery to a desired location.

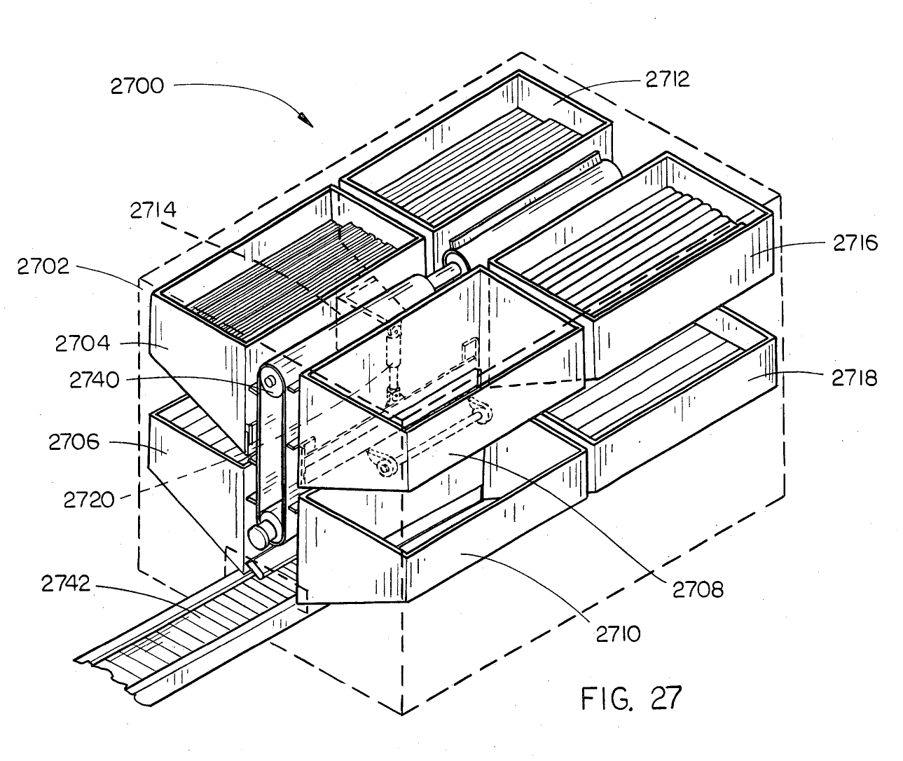

A multi-compartment hopper 2700, of FIG. 27, is comprised of a housing 2702 that includes a first compartment 2704, a second compartment 2706, a third compartment 2708, a fourth compartment 2710, a fifth compartment 2712, a sixth compartment 2714, a seventh compartment 2716, and an eighth compartment 2718. An access mechanism 2720, shown in the third compartment 2708, is included in each of the eight compartments. The multi-compartment hopper 2700 further includes a delivery system 2740 coupled to each of the access mechanisms, which delivers the work pieces to a conveyance mechanism 2742.

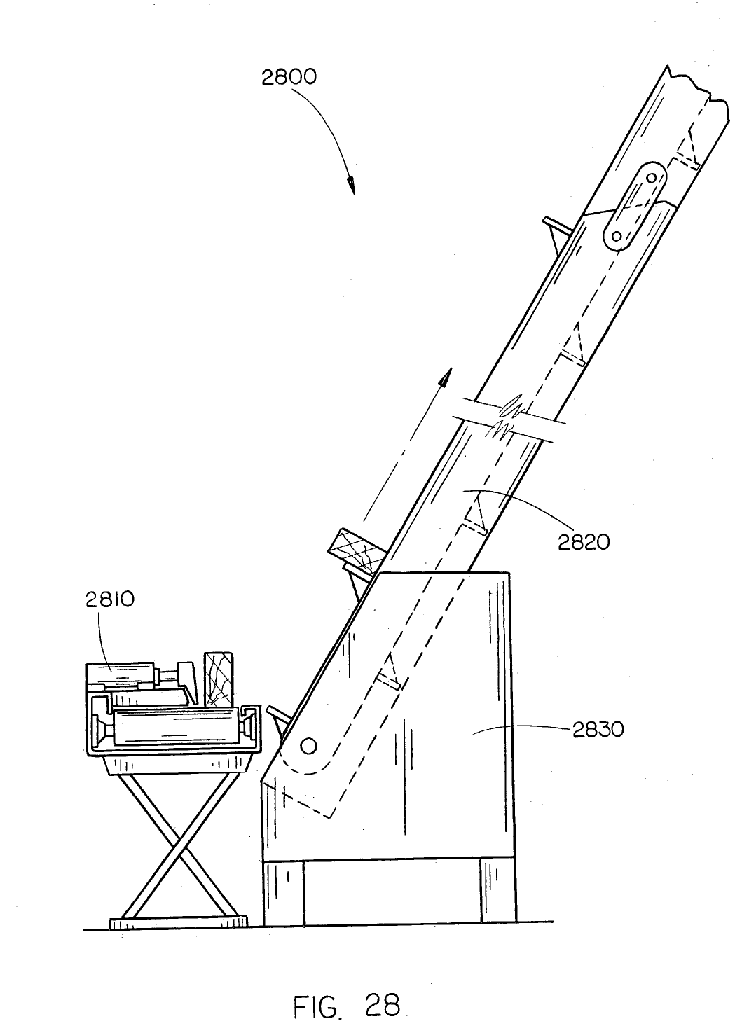

An elevator system 2800, is shown in FIG. 28, comprising a press 2810 for delivering the work piece to an elevator 2820, that includes a plurality of shelves, coupled to a drive box 2830. The drive box 2830 provides power to the elevator 2820 for delivery of the work pieces. The press 2810 is coupled to the conveyance mechanism and is in communication with the operator who provides the data to the modular assisted visualization system for the cutting and delivery of the work piece. Other elevator systems as contemplated by those of ordinary skill in the art may be employed without departing from the scope and spirit of the present invention.

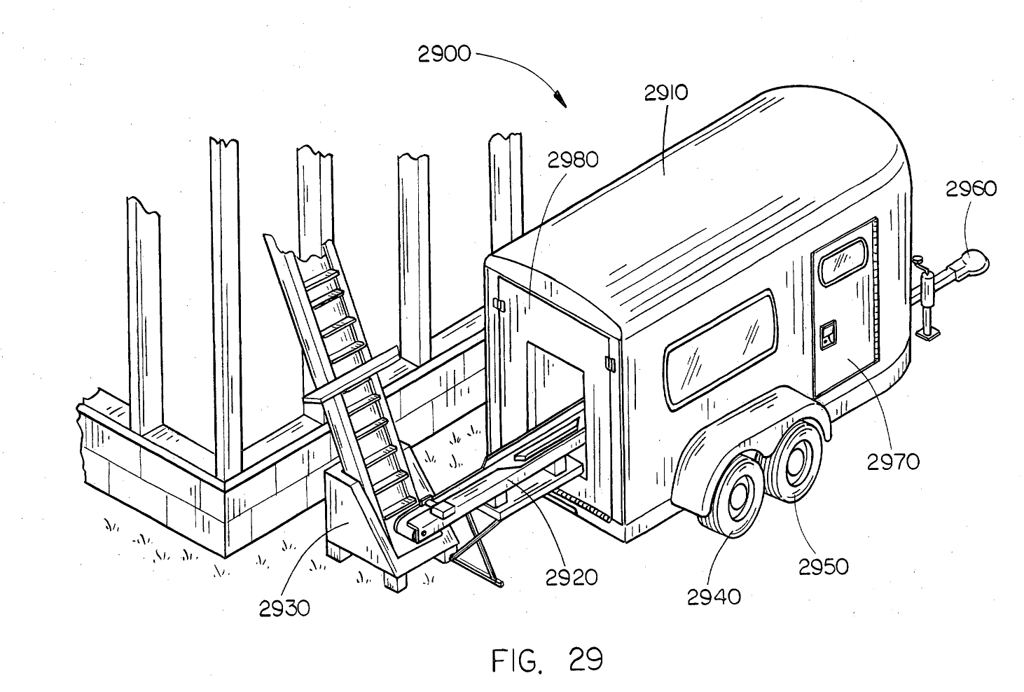

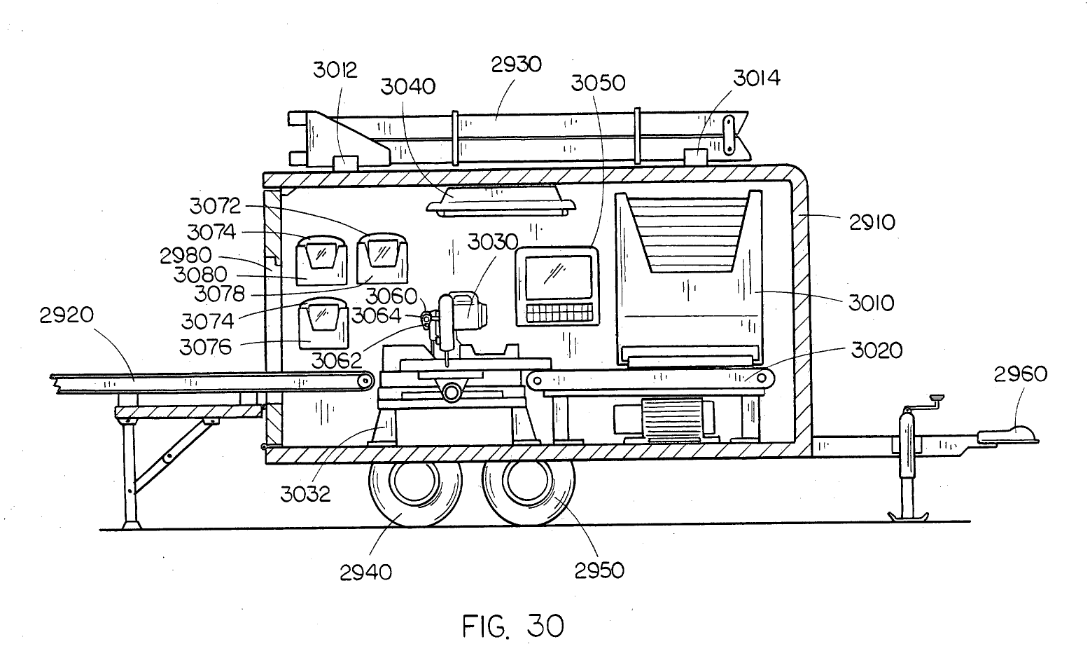

Referring to FIGS. 29 and 30, a portable work system 2900 is shown. The system 2900 includes a transportable housing 2910, a conveyance mechanism 2920, and an elevator system 2930 (similar to elevator system 2800 as described above). The transportable housing 2910, further includes, a hopper 3010, an indexer 3020, a circular saw 3030, a work light 3040 and a modular assisted visualization system. The modular assisted visualization system includes an image manipulation module 3050, a camera module 3060, and a plurality of remote image manipulation modules 3070, 3072, and 3074 stored in remote image manipulation modules storage compartments 3076, 3078, and 3080.

The image manipulation module 3050 is coupled to the housing 2910. The image manipulation module 3050 is in communication with each of the remote image manipulation modules, the camera module 3060, the work light 3040, the circular saw 3030, the hopper 3010, the indexer 3020, the conveyance mechanism 2920 and the elevator system 2930. The operator, therefore, may control the entire system 2900 by using the modular assisted visualization system. The camera module 3060 further includes a camera lens 3062 and a light 3064, described in previous figures. The circular saw 3030 is coupled with a support apparatus 3032, which in turn is connected to the housing 2910, to provide stability and place the circular saw 3030 at the proper height. It is contemplated that the support apparatus 3032 may provide vertical adjustment capabilities.

The elevator system 2930 may be coupled to the housing 2910 by mounting devices 3012 and 3014, for storage and transportation purposes. Additionally, the conveyance mechanism 2920 may be coupled to the housing 2910 for storage and transportation purposes. The housing 2910 is disposed with a first set of wheels 2940, a second set of wheels 2950, and a trailer hitch 2960. The housing 2910 further includes a first door 2970 and a second door 2980. The first door 2970 provides ingress/egress access for the operator and the second door 2980 allows the system to transport the work piece from the circular saw 3030 to the specified location for delivery by using the conveyance mechanism 2920 and the elevator system 2930.

The housing 2910 may include a third door located next to the hopper 3010 and indexer 3020. The third door may allow for an additional hopper (i.e., multi-compartment hopper) and indexer to be coupled with the indexer 3020. This provides additional resources to the operator of the system 2900. The housing 2910 may be a refrigerated unit. Such capabilities allow the system to remain cool when in operation and avoid malfunctions or system shut downs due to overheating. In a refrigerated housing, the modular assisted visualization system components, the hopper, the indexer, the circular saw and the conveyance mechanism are required to be temperature resistant. The housing 2910 may also include a dust collection system for collection of the debris generated by the circular saw 3030.

The hopper 3010 may be a multi-compartment hopper (as described previously). In the configuration of the housing 2910 with a third door, the loading of lumber into the hopper 3010 may be accomplished by using the third door. The work light 3040, coupled to the housing 2910 may be removable from the housing 2910. Additionally, the work light 3040 may provide an air filtration system as well as power outlets for additional tools.

The transportation of the system 2900 may, alternately, be in a self-propelled vehicle and not require a trailer hitch and a second vehicle to move the system 2900. Such a self-propelled vehicle may further include multiple systems, as shown in FIGS. 29 and 30, within a single housing. In such a system, providing a refrigerated unit may be even more important to avoid malfunctions and shut downs due to overheating.

In FIGS. 31A, 31B and 31C, a marker device 3100 placing an indicator upon the work piece that is identifiable by a camera module 3110, coupled to a circular saw 3120, in communication with the modular assisted visualization system, is shown. The marker device 3100 places a visually ascertainable indicator upon the work piece and, upon recognition of the indicator by a camera lens 3130 of the camera module 3110, the modular assisted visualization system lays down a grid or cut line on the indicator and executes a cut. The camera module further includes a light 3140.

Alternately, the marker device may place an indicator on the work piece which is not visually ascertainable but may be read by the camera lens 3130. The marker device 3100 may be capable of placing a variety of marks, such as an infrared mark, a metallic indicator or the like, on a work piece that may be imperceptible by the human eye.

The marker device 3100 is a handheld device that includes a switch 3102 that is depressed by the operator to place the indicator in the desired location. A removable cap 3104 is located at the end opposite of a marker 3106. Removal of the cap 3104 allows an operator to maintain the operability of the marker device 3100 by replacing ink cartridges or ensuring the proper functioning of an alternative marking system.

It is contemplated that the marker device 3100 may be coupled with a system to provide its marking function. For example, the marker device 3100 may be coupled to the conveyance mechanism in a location prior to the work piece entering the work area of the saw. The marker device 3100 may be in communication with a marker controller which is in communication with the image manipulation device, saw controller, or the remote image manipulation device of the modular assisted visualization system. Another example may include the marker device 3100 coupled with the indexer (as shown in FIG. 30). The control of the marker device 3100 may be determined by the operator of the system or the manufacturer of the system.

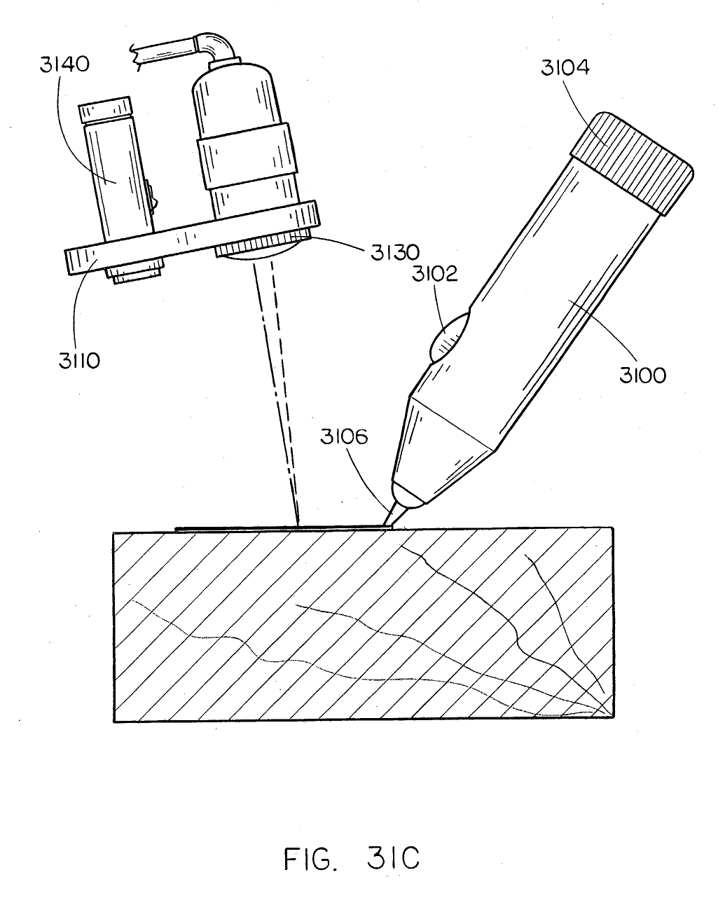

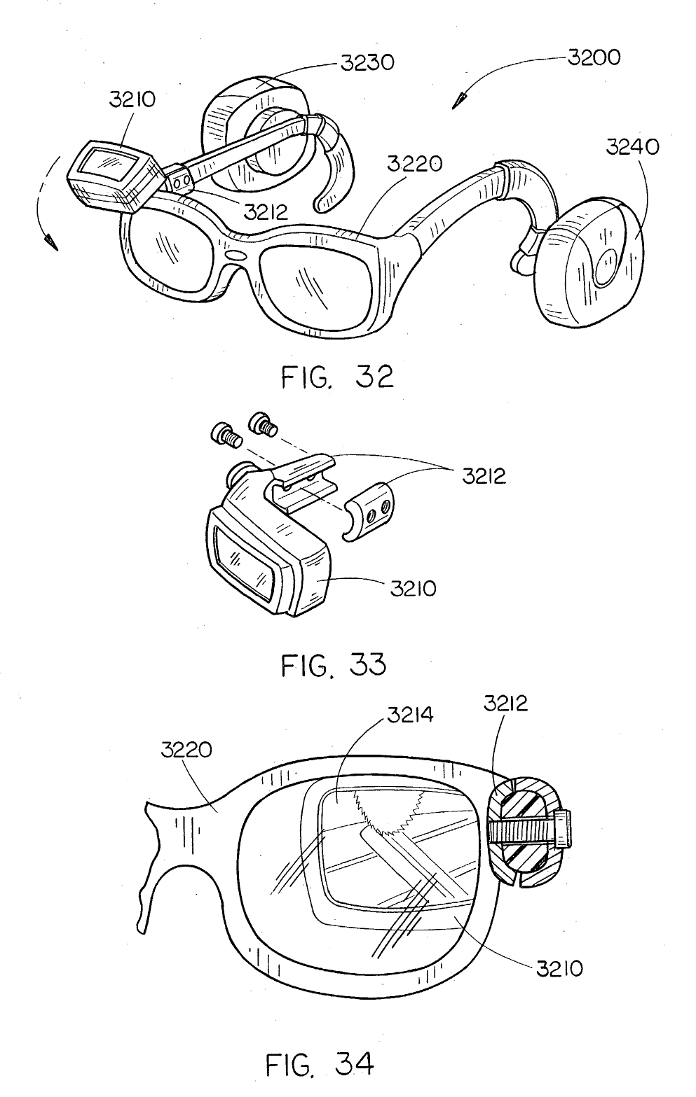

Referring to FIGS. 32 through 34, a remote image visualization system 3200 is shown. The remote image visualization system 3200 includes a remote image visualization module 3210, an operator eye protection unit 3220, a first operator ear protection unit 3230, and a second operator ear protection unit 3240. The remote image visualization module 3210 is coupled to the operator eye protection unit 3220 by a mounting sleeve 3212. The mounting sleeve 3212 allows an operator to attach and remove the remote image visualization module 3210 from the operator eye protection unit 3220. The remote image visualization module 3210 provides the operator, using the operator eye protection unit 3220, with a display 3214 of the image provided by the camera module of the modular assisted visualization system. This allows the hands of the operator to remain free while viewing the work area of the circular saw connected with the modular assisted visualization system.

The remote image visualization module 3210 is pivotally coupled with the mounting sleeve 3212. This allows the operator to maneuver the remote image visualization module 3210 out of the line of sight and still keep the remote image visualization module coupled to the operator eye protection unit 3220. It is contemplated that the remote image visualization module 3210 may provide the same capabilities as the remote image manipulation module of the modular assisted visualization system. This allows the operator to control the modular assisted visualization system while keeping his hands free at all times to execute other operations. It also reduces the tool storage needs of the operator when they are working, as the remote image visualization system 3210 is stored on the operator eye protection unit 3220.

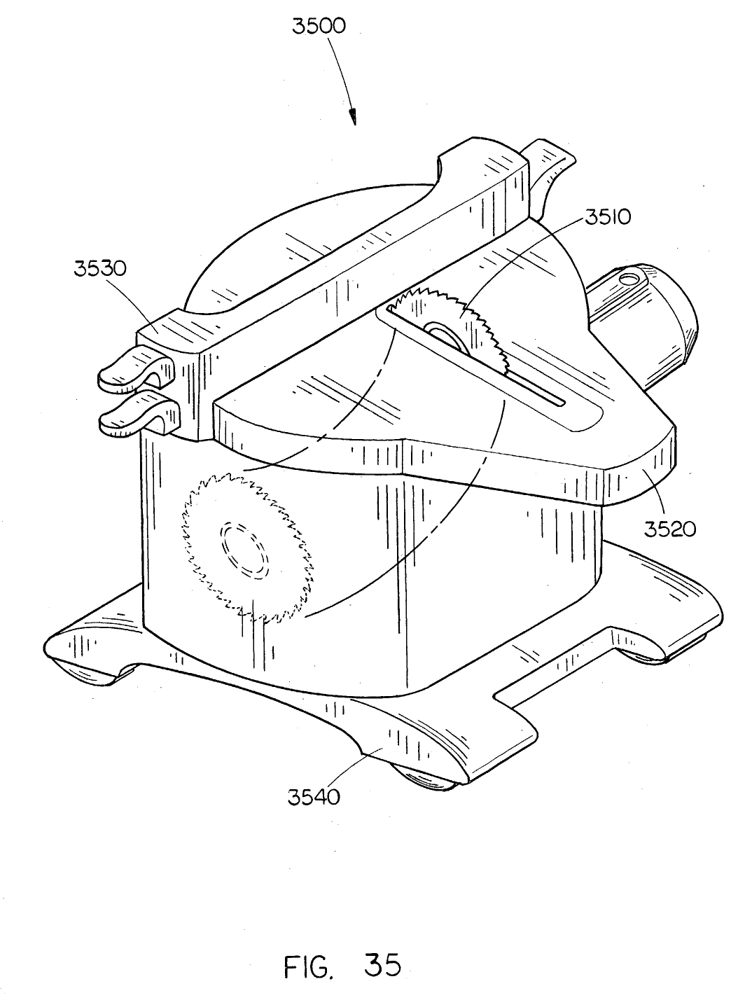

A table saw 3500, operable within the modular assisted visualization system, is shown in FIG. 35. The circular saw blade 3510 raises up through a base unit housing 3520 to execute a cut upon a work piece. The table saw 3500 further includes an adjustable work piece guidance mechanism 3530. The guidance mechanism 3530 allows an operator to determine the width of the cut made upon a work piece. It also provides stability to a work piece as it is moved across the work area of the table saw 3500.

In the present embodiment the table saw 3500 is disposed with a universal base 3540, however, the base may include wheels, such as casters and the like, providing the operator the capability of easily transporting the table saw 3500. The circular saw blade 3510 is raised in a fixed perpendicular orientation to the work area, however, it is contemplated that the table saw 3500 may include the capability to adjust the angle of the circular saw blade 3510. This provides the operator with the ability to perform angled cuts like a miter saw or bevel saw.

Referring to FIG. 36, a circular saw system 3600 including a housing 3610 and a circular saw unit 3615 including a circular saw blade 3620, is shown. The housing 3610 is disposed with a first door 3630 and a second door 3640. Each door is retractable into the housing 3610 to allow the work piece to be operated upon by the circular saw blade 3620. The housing 3610 is coupled with a standard base 3650. The base 3650 may include wheels to allow an operator to transport the system 3600.

Preferably, the housing 3610 includes a handle 3670, which allows an operator to adjust the vertical position of the housing 3610 relative to the base 3650. This provides the capability of matching the height of the circular saw blade 3620 work area with a conveyance mechanism or indexer. Additionally, the housing includes a light 3680 which indicates when the circular saw blade 3620 is in operation. The light 3680 is another protection feature to provide persons visual warning of when the blade is operating.

The circular saw system 3600 is operable within the modular assisted visualization system. The circular saw system 3600 may be in communication with an image manipulation module, a saw controller, or a remote image manipulation module. The housing 3610 may be disposed with a camera module, in communication with the image manipulation module or the remote image manipulation module, placed to the side of the circular saw blade 3620 and providing an image of the work area. Alternately, the modular assisted visualization system may include two or more camera modules disposed on the housing, on either side of the circular saw blade 3620. Additionally, the circular saw system 3600 may include a cooling system inside the housing to keep the work area as well as the circular saw unit 3615 cool to avoid malfunctions and shut downs.

Referring to FIG. 37, a system 3700 including a modular assisted visualization system coupled with a water jet cutter system 3714, a hopper 3716, and a conveyance mechanism 3718, is shown. The modular assisted visualization system includes a first measuring device 3702 and a second measuring device 3706 in communication with a first remote image manipulation module 3704 and a second remote image manipulation module 3708, respectively.

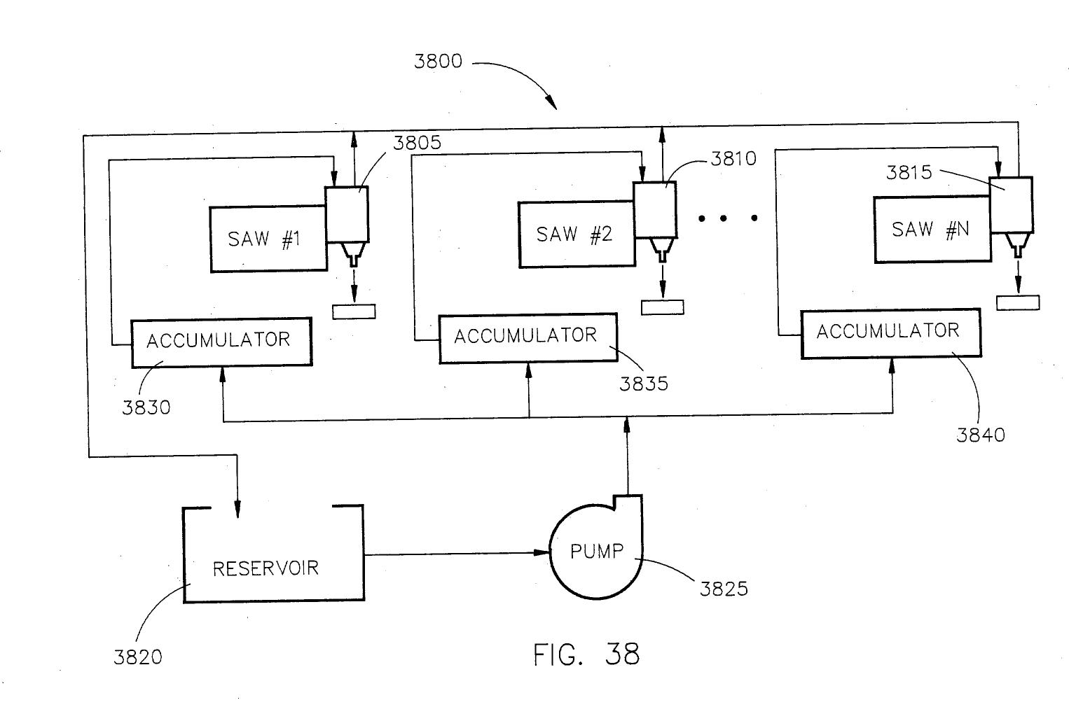

Each of the remote image manipulation modules is in communication with an image manipulation module 3710 which is also in communication with a camera module 3712 and the water jet cutter system 3714. The water jet cutter system includes a water jet cutter, a reservoir, a pump and an accumulator, as will be described below in FIG. 38. Additionally, the water jet cutter of the water jet cutter system 3710 may include the capability of making angled cuts.

A multiple water jet cutter system 3800 is shown in FIG. 38. The system 3800 includes a first water jet cutter 3805, a second water jet 3810 and an N water jet cutter 3815. The N represents that the number of water jet cutters which may be included within the system 3800 may vary. Coupled to all of the water jet cutters is a reservoir 3820 which receives the excess water left over after the water jet cutter cuts a work piece. A pump 3825 takes the water from the reservoir 3820 and pumps it back into a first accumulator 3830, a second accumulator 3835 and an N accumulator 3840. Each of the accumulators is coupled to one of the water jet cutters.

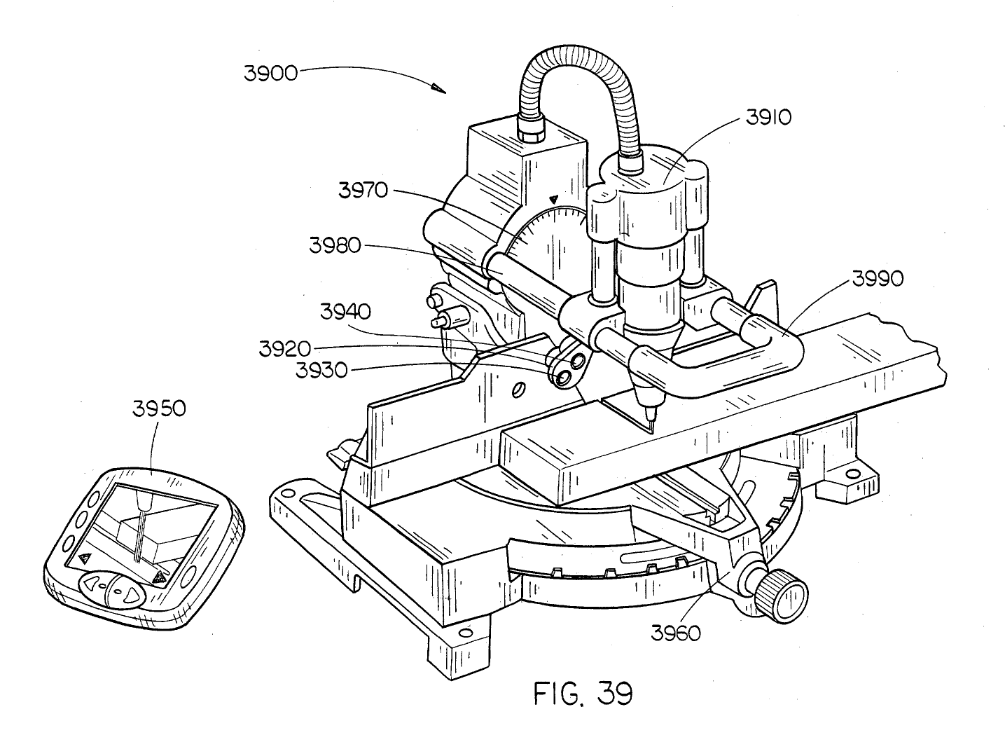

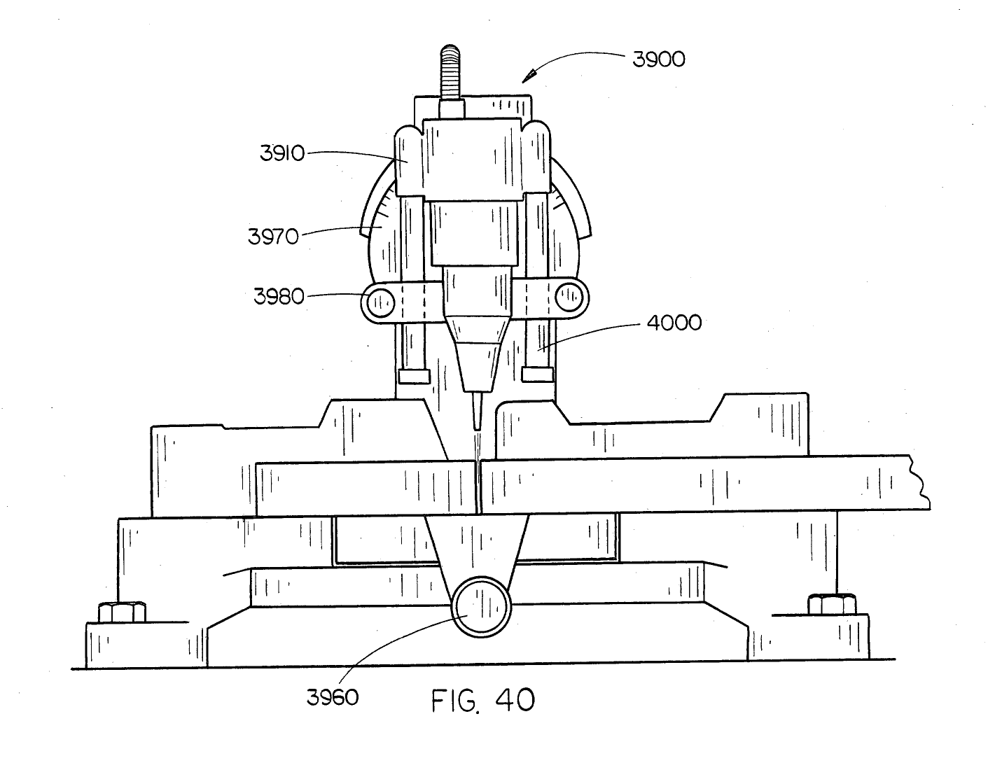

Referring to FIGS. 39 and 40, a water jet cutter system 3900 operable within a modular assisted visualization system, is shown. The water jet cutter system 3900 includes a water jet cutter 3910 coupled with a camera module 3920 that includes a camera lens 3930 and a light 3940. The camera module 3920 is in communication with a remote image manipulation module 3950 and provides an image of the work area of the water jet cutter 3910 which is displayed on the screen of the remote image manipulation module 3950.

Preferably, the water jet cutter system 3900 also includes a width of cut controller mechanism 3980. This mechanism includes a handle 3990 which allows an operator to, manually, pull the water saw 3910 across the work piece in the execution of a cut. The controller mechanism 3980, alternately, may be in communication with an image manipulation module of the modular assisted visualization system and, therefore controlled indirectly by an operator entering data into the image manipulation module which relays the data to the controller mechanism 3980.

The water jet cutter 3910 includes the ability to produce angled cuts. An angle of cut mechanism 3960 is coupled to the water jet cutter 3910 to allow an operator to set the precise angle of cut that is desired. In the present embodiment a bevel cut angle indicator 3970 is coupled to the water jet cutter 3910 to provide precise measurements of the angle of cut being produced by the water jet cutter system 3900.

The water jet cutter system further includes a depth of cut controller mechanism 4000. This mechanism allows an operator to manually adjust the depth of cut performed by the water jet cutter 3910 on the work piece. The controller mechanism 4000, alternately, may be in communication with an image manipulation module of the modular assisted visualization system and, therefore controlled indirectly by an operator entering data into the image manipulation module which relays the data to the controller mechanism 4000.

In the exemplary embodiments, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method may be rearranged while remaining within the scope and spirit of the present invention. The accompanying method claims present elements of the various steps in a sample order, and are not necessarily meant to be limited to the specific order or hierarchy presented.

It is believed that the modular assisted visualization system of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A modular assisted visualization system, comprising:
a work piece manipulation device for executing a function upon a work piece located in a work area of the work piece manipulation device;
a camera module connected to the work piece manipulation device for providing a visual image of the work area; and
an image manipulation module in communication with the camera module, for manipulating the visual image of the work area, and the work piece manipulation device,
wherein the work piece manipulation device assisted visualization system establishes at least one of a grid and a cut line on a work piece in the work area for identifying the location on the work piece that the work piece manipulation device executes its function.

2. The modular assisted visualization system of claim 1, wherein the work piece manipulation device is at least one of a circular saw, a laser cutter, a water jet cutter, a drill, a sander, and a lathe, for providing execution of a desired function upon the work piece.

3. The modular assisted visualization system of claim 2, wherein the work piece manipulation device is disposed within a housing.

4. The modular assisted visualization system of claim 2, further comprising a work piece manipulation device controller coupled to the work piece manipulation device and in communication with the image manipulation module, for providing programmable control over the work piece manipulation device.

5. The modular assisted visualization system of claim 4, wherein the work piece manipulation device controller is remotely located from the work piece manipulation device.

6. The modular assisted visualization system of claim 1, further comprising a measuring device in communication with the image manipulation module, for providing measurements to establish the at least one of the grid and the cut line.

7. The modular assisted visualization system of claim 1, further comprising a marking device, which places an indicator upon the work piece that is identified by the image manipulation module in communication with the camera module for execution by the work piece manipulation device upon the indicator.

8. The modular assisted visualization system of claim 1, further comprising a safety guard disposed upon the work piece manipulation device.

9. The modular assisted visualization system of claim 8, wherein the safety guard is removable from the work piece manipulation device.

10. The modular assisted visualization system of claim 1, wherein the image manipulation module includes a remote image manipulation module.

11. The modular assisted visualization system of claim 1, wherein the image manipulation module, in communication with the camera module, includes an image enhancer capability, for providing a virtual image of the work area, free from debris.

12. The modular assisted visualization system of claim 1, wherein the camera module is removable from the work piece manipulation device.

13. The modular assisted visualization system of claim 1, further comprising a light connected to at least one of the work piece manipulation device and the camera module, for providing improved lighting of the work area.

14. The modular assisted visualization system of claim 1, further comprising a remote viewing module in communication with the camera module and the image manipulation module.

15. The modular assisted visualization system of claim 1, further comprising a clamping mechanism connected to the work piece manipulation device.

16. A modular assisted visualization system, comprising:
a saw for cutting a work piece located in a work area of the saw;
a camera module connected to the saw for providing a visual image of the work area of the saw; and
an image manipulation module in communication with the camera module, for displaying the image of the work area, and the saw.
wherein the modular assisted visualization system establishes at least one of a grid and a cut line on a work piece in the work area for identifying the location on the work piece that the saw executes its cut and executing the cut upon the work piece.

17. The modular assisted visualization system of claim 16, wherein the saw is at least one of a miter saw, a radial arm saw and a table saw.

18. The modular assisted visualization system of claim 16, wherein the saw is at least one of a laser cutter, a water jet cutter, a drill, a sander, and a lathe.

19. The modular assisted visualization system of claim 18, wherein the saw is disposed within a housing.

20. The modular assisted visualization system of claim 16, further comprising a saw controller coupled to the saw and in communication with the image manipulation module, for providing programmable control over the functioning of the saw.

21. The modular assisted visualization system of claim 20, wherein the saw controller is remotely located from the saw.

22. The modular assisted visualization system of claim 16, further comprising a measuring device in communication with the image manipulation module, for providing measurements to establish the cut line.

23. The modular assisted visualization system of claim 16, further comprising a marking device, which places an indicator upon the work piece that is identified by the image manipulation module in communication with the camera module for execution by the saw upon the indicator.

24. The modular assisted visualization system of claim 16, further comprising a safety guard coupled to the saw.

25. The modular assisted visualization system of claim 24, wherein the safety guard is removable from the saw.

26. The modular assisted visualization system of claim 16, wherein the image manipulation module includes a remote image manipulation module.

27. The modular assisted visualization system of claim 26, wherein the image manipulation module, in communication with the camera module, includes an image enhancer capability, for providing a virtual image of the work area, free from debris.

28. The modular assisted visualization system of claim 16, wherein the camera module is removable from the saw.

29. The modular assisted visualization system of claim 16, further comprising a light connected to at least one of the saw and the camera module, for providing improved lighting of the work area.

30. The modular assisted visualization system of claim 16, further comprising a remote viewing module in communication with the camera module and the image manipulation module.

31. The modular assisted visualization system of claim 16, further comprising a clamping mechanism connected to the saw.

32. A system for providing a finished work piece, comprising:
a programmable work piece hopper for providing storage and access to a selected work piece;
a saw connected to a saw controller and coupled with the work piece hopper for cutting the selected work piece within a work area of the saw;
a camera module connected to the saw for providing a visual image of the work area of the saw;
am image manipulation module in communication with the programmable work piece hopper, the saw controller and the camera module for providing the capability to select and access the work piece, establish a cut line on the selected work piece and engage the saw upon the cut line; and
a programmable conveyance mechanism in communication with the image manipulation module and coupled with the programmable work piece hopper and the saw for indexing and delivering the selected work piece,
wherein the system enables the selection and retrieval of the work piece, the cutting of the selected work piece to a desired finished product and the delivery of a finished work piece.

33. The system of claim 32, wherein the saw is at least one of a miter saw, a radial arm saw and a table saw.

34. The system of claim 32, wherein the saw is at least one of a laser cutter, a water jet cutter, a drill, a sander, and a lathe.

35. The system of claim 34, wherein the saw is disposed within a housing.

36. The system of claim 32, wherein the saw controller is remotely located from the saw.

37. The system of claim 32, further comprising a measuring device in communication with the image manipulation module, for providing measurements to establish the cut line.

38. The system of claim 32, further comprising a marking device, which places an indicator upon the work piece that is identified by the image manipulation module in communication with the camera module and the programmable saw controller, for execution by the saw upon the indicator.

39. The system of claim 32, further comprising a safety guard disposed upon the programmable saw.

40. The system of claim 39, wherein the safety guard is removable from the saw.

41. The system of claim 32, wherein the image manipulation module is a remote image manipulation module.

42. The system of claim 41, wherein the image manipulation module, in communication with the camera module, includes an image enhancer capability, for providing a virtual image of the work area, free from debris.

43. The system of claim 32, wherein the camera module is removable from the saw.

44. The system of claim 34, further comprising a remote viewing module in communication with the camera module.

45. The system of claim 32, further comprising a light connected to at least one of the saw and the camera module, for providing improved lighting of the work area.

46. The system of claim 32, further comprising a clamping mechanism connected to the saw.

47. The system of claim 32, further comprising an enclosure, for providing a portable system for providing a finished work piece.

48. A modular assisted visualization system, comprising:
means for manipulating a work piece received in a work area of the work piece manipulation means;
means for viewing an image of a work area connected to the means for manipulating a work piece; and
means for manipulating the image of the work area in communication with the viewing means and means for manipulating the work piece,
wherein the modular assisted visualization system is capable of establishing at least one of a grid and a cut line for locating the execution of the work piece manipulation means upon the work piece.

49. The modular assisted visualization system of claim 48, wherein the means for manipulating a work piece is at least one of a circular saw, a laser, a water jet cutter, a drill, a sander and a lathe, for providing execution of a desired function upon the work piece.

50. The modular assisted visualization system of claim 49, wherein the work piece manipulation device is a plurality of work piece manipulation devices.

51. The modular assisted visualization system of claim 50, wherein the work piece manipulation device is disposed within a housing.

52. The modular assisted visualization system of claim 48, wherein the means for viewing an image of the work area is a camera module.

53. The modular assisted visualization system of claim 52, wherein the camera module is removable from the means for manipulating a work piece.

54. The modular assisted visualization system of claim 52, further comprising a remote viewing module in communication with the camera module.

55. The modular assisted visualization system of claim 48, wherein the means for manipulating the image provided by the viewing means is an image manipulation module for establishing the at least one of the grid and the cut line.

56. The modular assisted visualization system of claim 55, wherein the image manipulation module, in communication with the camera module, includes an image enhancer capability, for providing a virtual image of the work area, free from debris.

57. The modular assisted visualization system of claim 55, further comprising a measuring device in communication with the image manipulation module, for providing measurements to establish the at least one of the grid and the cut line.

58. The modular assisted visualization system of claim 55, further comprising a marking device, which places an indicator upon the work piece that is identified by the image manipulation module in communication with the camera module for execution by the saw upon the indicator.

59. The modular assisted visualization system of claim 55, wherein the image manipulation module is a remote image manipulation module.

60. The modular assisted visualization system of claim 48, further comprising a safety guard disposed upon the means for manipulating the work piece.

61. The modular assisted visualization system of claim 60, wherein the safety guard is removable from the means for manipulating the work piece.

62. The modular assisted visualization system of claim 48, further comprising a light coupled with at least one of the work piece manipulation means and the viewing means, for providing improved lighting.

63. The modular assisted visualization system of claim 48, further comprising a clamping mechanism coupled with the work piece manipulation means.

64. A method for manipulating a work piece, comprising:
selecting the work piece using an image manipulation module in communication with a programmable work piece hopper where the work piece is stored and accessible;
providing a work piece manipulation device including a work area, in communication with the image manipulation module;
conveying the selected work piece using a programmable conveyance mechanism connected to the work piece manipulation device and in communication with the image manipulation module, for delivering the work piece to a desired location;
viewing the work area of the work piece manipulation device, utilizing a camera module connected to the work piece manipulation device and in communication with the image manipulation module, for providing a visual image of the work piece in the work area;
establishing at least one of a grid and a cut line on the work piece in the work area, using the image manipulation module, for providing a location for the execution of a work piece manipulation device function upon the work piece; and
executing the work piece manipulation device function upon the at least one of the grid and the cut line identified location on the work piece.

65. The method of claim 64, wherein selecting the work piece further comprises the step of providing a work piece hopper with a plurality of compartments including a plurality of work pieces.

66. The method of claim 64, wherein selecting the work piece further comprises the step of providing a visual image of the plurality of work pieces disposed in the work piece hopper on at least one of the image manipulation module and a remote image manipulation module.

67. The method of claim 64, wherein the providing of the work piece manipulation device further comprises the step of providing at least one of a circular saw, a sander, a lathe, a drill, a laser cutter, and a water jet cutter.

68. The method of claim 64, wherein the conveying of the selected work piece further comprises the step of marking the work piece with a marker, before the work piece is delivered to the work piece manipulation device, with at least one of a visible indicator and a mechanically readable indicator.

69. The method of claim 64, wherein the viewing of the work area further comprises the step of providing a virtual image of the work area.

70. The method of claim 64, wherein the establishing of at least one of a grid and a cut line on the work piece further comprises the step of indexing the work piece in the work area of the work piece manipulation device, in accordance with measurements provided by a measurement device, using the conveyance mechanism in communication with the image manipulation module which is in communication with the camera module.

71. The method of claim 69, wherein the establishing of at least one of a grid and a cut line on the work piece further comprises the step of identifying the at least one of the visible indicator and the mechanically readable indicator by the image manipulation module in communication with the camera module.

72. The method of claim 64, wherein the executing of the work piece manipulation device function upon the work piece further comprises the step of providing a work piece manipulation device controller in communication with the work piece manipulation device and the image manipulation module.

73. The method of claim 64, wherein the executing of the work piece manipulation device function upon the work piece further comprises the step of providing a safety guard connected to the work piece manipulation device.
